(19) United States
(12) Patent Application Publication
(10) Pub. No.: US 2005/0286430 A1
(43) Pub. Date: Dec. 29, 2005

(54) Abnormal traffic eliminating apparatus

(75) Inventors: Yoshihiko Koga, Yokohama (JP); Wataru Nakamura, Yokohama (JP); Tetsuya Nishi, Kawasaki (JP); Ryoichi Mutoh, Kawasaki (JP); Hiroaki Yamamoto, Yokohama (JP)

Correspondence Address: SWIDLER BERLIN LLP, 3000 K STREET, NW, BOX IP, WASHINGTON, DC, 20007, US

(73) Assignee: Fujitsu Limited

(21) Appl. No.: 11/061,695

(22) Filed: Feb. 22, 2005

(30) Foreign Application Priority Data
Jun. 24, 2004 (JP) 2004-185831

(51) Int. Cl. H04L 12/26

(52) U.S. Cl. 370/241

(57) ABSTRACT

An abnormal traffic eliminating apparatus eliminates an abnormal traffic that is generated in a network through which frames including a MAC header part, an IP header part and an IP datagram part are transmitted. The apparatus is provided with a write part for writing an FCS field of an MAC frame that is received by a plurality of ports to a search engine part, and a loop monitoring and detecting part counting a number of received MAC frames having identical FCS values and judging that the network is in a loop state if the number of received MAC frames having the identical FCS values and received within a predetermined time exceeds a preset threshold value.

This application claims the benefit of a Japanese Patent Application No. 2004-185831 filed Jun. 24, 2004, in the Japanese Patent Office, the disclosure of which is hereby incorporated by reference.

### BACKGROUND OF THE INVENTION

1. Field of the Invention

The present invention generally relates to abnormal traffic eliminating apparatuses for eliminating abnormal traffic in a network, and more particularly to an abnormal traffic eliminating apparatus for eliminating an abnormal traffic caused by Media Access Control (MAC) frames or the like that are repeatedly transferred in a loop-shaped path within the network, and an abnormal traffic caused by a large amount of Internet Protocol (IP) frames or the like that is transmitted from a specific terminal to a large number of unspecified destinations by an intentional or malicious and annoying act of attacking the network (hereinafter simply referred to as an “attack”).

2. Description of the Related Art

A network is conventionally formed by using a bridge apparatus as a relay apparatus. When forming the network using the bridge apparatus as the relay apparatus so that an abnormal traffic caused by a loop will not be generated, it is necessary to take measures so that the loop will not be generated by broadcast frames. A Spanning Tree Protocol (SPT) is popularly used as a general technique for prevent the abnormal traffic caused by the loop.

FIGS. 4A and 4B respectively are diagrams showing a network having a tree structure and a network having a loop connection. The networks shown in FIGS. 4A and 4B respectively include a server 100, a plurality of relay apparatuses 101 and a plurality of Personal Computers (PCs) 102. A loop is not generated in the network having the tree structure shown in FIG. 4A, but a loop connection is formed in the network having the structure shown in FIG. 4B. Most relay apparatuses (bridge apparatuses) are designed to cope with the STP, and no abnormal traffic due to the loop connection will be generated if the relay apparatuses perform a normal operation.

However, an abnormal traffic will be generated by a loop that is formed by an erroneous connection and/or an erroneous setting and/or an equipment failure which cause a Bridge Protocol Data Unit (BPDU) packet loss or the like. For example, FIG. 5 shows a case where a loop is formed due to connection of input and output ports of a relay apparatus 101-1. As will be described later, FIG. 5 is a diagram for explaining an application an abnormal traffic eliminating apparatus according to the present invention. In FIG. 5, those parts which are the same as those corresponding parts in FIGS. 4A and 4B are designated by the same reference numerals, and a description thereof will be omitted.

In addition, in a case where the relay apparatus is not designed to cope with the STP or, does not use the STP, a loop may be formed due to an error in the network design. As a conventional technique for avoiding the loop formation, there is a technique which learns a transmitting source MAC address within a frame that is received by each of a plurality of ports, and restricts the trunking of the frames when the frames having the same transmitting source address is received by the plurality of ports.

But according to this conventional technique, it is possible to detect a loop traffic caused by incoming frames from bi-directional paths, but it is not possible to detect a loop traffic caused by incoming frames from only one direction. Moreover, with respect to the frames having the same transmitting source MAC address, such as broadcast frames and multicast frames, there is a possibility of erroneously recognizing the frames as being caused by the loop formation.

On the other hand, a firewall is provided in general as a technique for defending from an attack to prevent an abnormal traffic from being generated by the attack. The firewall protects an internal network from intrusions and attacks from an external network by filtering the incoming frames, based on a transmitting source IP address, a protocol type belonging to a transport layer or a Transmission Control Protocol/User Datagram Protocol (TCP/UDP) destination port number.

However, in the case of the firewall, it is difficult to cope with an attack (for example, port scan) with respect to a plurality of TCP/UDP destination port numbers, since it is necessary to filter all frames. The firewall is set up at a boundary of the external network and the internal network, and for this reason, it is effective against intrusions from the outside. But the firewall cannot defend the internal network from attacks from within the internal network, such as virus infection.

The applicants are aware of the following prior art in the field of network failure detection and loop failure detection. A Japanese Laid-Open Patent Application No. 8-139722 proposes a network failure prediction apparatus which judges a generation of a network failure from intervals at which Frame Check Sequence (FCS) errors are generated. A Japanese Laid-Open Patent Application No. 11-331235 proposes a cable modem system and a cable modem terminating apparatus which send an inspection frame having transmitting source information and transmitting direction information, and detect a loop failure based on receiving direction information and the information within the inspection frame when the inspection frame is received.

The problems of the conventional techniques are as follows. That is, in the case of the abnormal traffic caused by the loop, the loop with respect to the broadcast frames is monitored by determining whether or not frames having the same transmitting source MAC address are received by a plurality of reception ports. For this reason, in the case of a uni-directional loop shown in FIG. 4B, it is impossible to eliminate the loop traffic. In addition, when monitoring the loop formation based on the transmitting source MAC address, there is a possibility of erroneously recognizing the frames, such as the broadcast frames and multicast frames having the same transmitting source MAC address, as being caused by the loop formation.

Moreover, when the IP address, the protocol type or the TCP/UDP port number is used as a search key for the filtering with respect to the abnormal traffic caused by an attack, it is necessary to predict an attack pattern in advance. As a result, it is impossible to cope with a new attack. Furthermore, when a plurality of terminals transmit a large amount of packets, the defense using the IP address as the search key cannot cope with the attack. In addition, since the main intent of an attacker who transmits a large amount of packets is to cause a system failure of the network apparatus, it is important to prevent such a system failure.

### SUMMARY OF THE INVENTION

Accordingly, it is a general object of the present invention to provide a novel and useful abnormal traffic eliminating apparatus in which the problems described above are suppressed.

Another and more specific object of the present invention is to provide an abnormal traffic eliminating apparatus which can avoid a network from becoming unstable and a system failure from occurring, by reducing or eliminating a band of an abnormal traffic caused by a loop, an attack or the like, so that a network operation can be continued.

Another specific object of the present invention is to provide an abnormal traffic eliminating apparatus which is capable of immediately collecting information for specifying a cause of an abnormal traffic when the abnormal traffic is generated.

Still another object of the present invention is to provide an abnormal traffic eliminating apparatus for eliminating an abnormal traffic that is generated in a network through which frames including a MAC header part, an IP header part and an IP datagram part are transmitted, comprising a write part configured to write a Frame Check Sequence (FCS) field of an MAC frame that is received by a plurality of ports to a search engine part; and a loop monitoring and detecting part configured to count a number of received MAC frames having identical FCS values and to judge that the network is in a loop state if the number of received MAC frames having the identical FCS values and received within a predetermined time exceeds a preset threshold value. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

A further object of the present invention is to provide an abnormal traffic eliminating apparatus for eliminating an abnormal traffic that is generated in a network through which frames including a MAC header part, an IP header part and an IP datagram part are transmitted, comprising a write part configured to write a TCP/UDP destination port number field of an IPv4 frame that is received from the network to a search engine part; and a statistic part configured to count a number of received IPv4 frames having identical TCP/UDP destination port numbers and to process statistics for each TCP/UDP destination port number. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

Another object of the present invention is to provide an abnormal traffic eliminating apparatus for eliminating an abnormal traffic that is generated in a network through which frames including a MAC header part, an IP header part and an IP datagram part are transmitted, comprising a write part configured to write a TCP/UDP destination port number field, a Protocol field and an IPSA field of an IPv4 frame that is received from the network to a search engine part; and a statistic part configured to count a number of received IPv4 frames having identical TCP/UDP destination port number fields, Protocol fields and IPSA fields, and to process statistics for each TCP/UDP destination port number per IPSA. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

Still another object of the present invention is to provide an abnormal traffic eliminating apparatus for eliminating an abnormal traffic that is generated in a network through which frames including a MAC header part, an IP header part and an IP datagram part are transmitted, comprising a write part configured to write an IPDA field and an IPSA field of an IPv4 frame that is received from the network to a search engine part; and a statistic part configured to count a number of received IPv4 frames having identical IPDA fields and IPSA fields, and to process statistics for an IP destination port number per IPSA. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

A further object of the present invention is to provide an abnormal traffic eliminating apparatus for eliminating an abnormal traffic that is generated in a network through which frames including a MAC header part, an IP header part and an IP datagram part are transmitted, comprising a write part configured to write an IPSA field of an ARP frame that is received from the network to a search engine part; and a statistic part configured to count a number of received ARP frames having identical IPSA fields and to process statistics for an ARP frame number per IPSA. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

Another object of the present invention is to provide an abnormal traffic eliminating apparatus for eliminating an abnormal traffic that is generated in a network through which frames including a MAC header part, an IP header part and an IP datagram part are transmitted, comprising a write part configured to write an IPSA field of an ICMP frame that is received from the network to a search engine part; and a statistic part configured to count a number of received ICMP frames having identical IPSA fields and to process statistics for an ICMP frame number per IPSA. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

Still another object of the present invention is to provide an abnormal traffic eliminating apparatus for eliminating an abnormal traffic that is generated in a network through which frames including a MAC header part, an IP header part and an IP datagram part are transmitted, comprising a monitoring part comprising a first part configured to determine whether or not a traffic flow rate of MAC frames received by a plurality of ports exceeds a first threshold value, a second part configured to determine whether or not a number of IPv4 frames received from the network and having identical TCP/UDP destination port numbers exceeds a second threshold value, a third part configured to determine whether or not a number of IPv4 frames received from the network and having identical TCP/UDP destination port number fields, Protocol fields and IPSA fields exceeds a third threshold value, a fourth part configured to determine whether or not a number of received IPv4 frames received from the network and having identical IPDA fields and IPSA fields exceeds a fourth threshold value, a fifth part configured to determine whether or not a number of ARP frames received from the network and having identical IPSA fields exceeds a fifth threshold value, and a sixth part configured to determine whether or not a number of ICMP frames received from the network and having identical IPSA fields exceeds a sixth threshold value; and a monitoring and detecting part configured to judge that an abnormal traffic has occurred due to an attack if one of the first through sixth threshold values is exceeded in the monitoring part continuously for a predetermined time. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

A further object of the present invention is to provide an abnormal traffic eliminating apparatus for eliminating an abnormal traffic that is generated in a network through which frames including a MAC header part, an IP header part and an IP datagram part are transmitted, comprising a divided mode in which monitoring, detecting; statistical and blocking operations with respect to loop/attacking frames received by a plurality of ports are carried out for each physical port number of the ports, where the frames including IPv4 TCP/UDP frames, IPv4 ARP frames and IPv4 ICMP frames; a shared mode in which the monitoring, detecting, statistical and blocking operations with respect to the loop/attacking frames received by the plurality of ports are carried out without separating the process for each physical port number of the ports; and a selecting part configured to select and carrying out the process in the divided mode or the shared mode. According to the abnormal traffic eliminating apparatus of the present invention, it is possible to avoid the network from becoming unstable and a system failure from occurring, so that a network operation can be continued. If necessary, measures may be take so that it is possible to immediately collect information for specifying a cause of the abnormal traffic when the abnormal traffic is generated.

Other objects and further features of the present invention will be apparent from the following detailed description when read in conjunction with the accompanying drawings.

### BRIEF DESCRIPTION OF THE DRAWINGS

FIG. 1 is a diagram showing an general structure of an embodiment of an abnormal traffic eliminating apparatus according to the present invention;

FIG. 2 is a flow chart for explaining a loop eliminating process;

FIG. 3 is a flow chart for explaining an attack eliminating process;

FIGS. 4A and 4B respectively are diagrams showing a network having a tree structure and a network having a loop connection;

FIG. 5 is a diagram for explaining an application of the embodiment of the abnormal traffic eliminating apparatus according to the present invention;

FIG. 6 is a diagram showing an IPv4 frame format without VLAN_Tag;

FIG. 7 is a diagram showing an IPv4 frame format with VLAN_Tag;

FIG. 8 is a diagram showing an ARP frame format without VLAN_Tag;

FIG. 9 is a diagram showing an ARP frame format with VLAN_Tag;

FIG. 10 is a diagram showing an ICMP frame format without VLAN_Tag;

FIG. 11 is a diagram showing an ICMP frame format with VLAN_Tag;

FIG. 12 is a diagram showing a search keyword structure;

FIG. 13 is a diagram showing structures of a loop monitoring table and an FCS frame count table;

FIG. 14 is a diagram showing a structure of an attack TCP/UDP destination port number monitoring table;

FIG. 15 is a diagram showing a structure of a TCP/UDP destination port number monitoring table per attack IPSA;

FIG. 16 is a diagram showing a structure of an IP destination number monitoring table per attack IPSA;

FIG. 17 is a diagram showing a structure of an ARP monitoring table per attack IPSA;

FIG. 18 is a diagram showing a structure of an ICMP monitoring table per attack IPSA;

FIGS. 19A through 19D are diagrams for explaining a validity inspection of a received frame and the like;

FIGS. 20A through 20C are diagrams for explaining a search keyword extraction and the like;

FIGS. 21A through 21C are diagrams for explaining a loop frame blocking combination and the like;

FIGS. 22A and 22B are diagrams for explaining a search code generation and the like; and

FIGS. 23A and 23B are diagrams for explaining a protocol analysis and the like.

### DESCRIPTION OF THE PREFERRED EMBODIMENTS

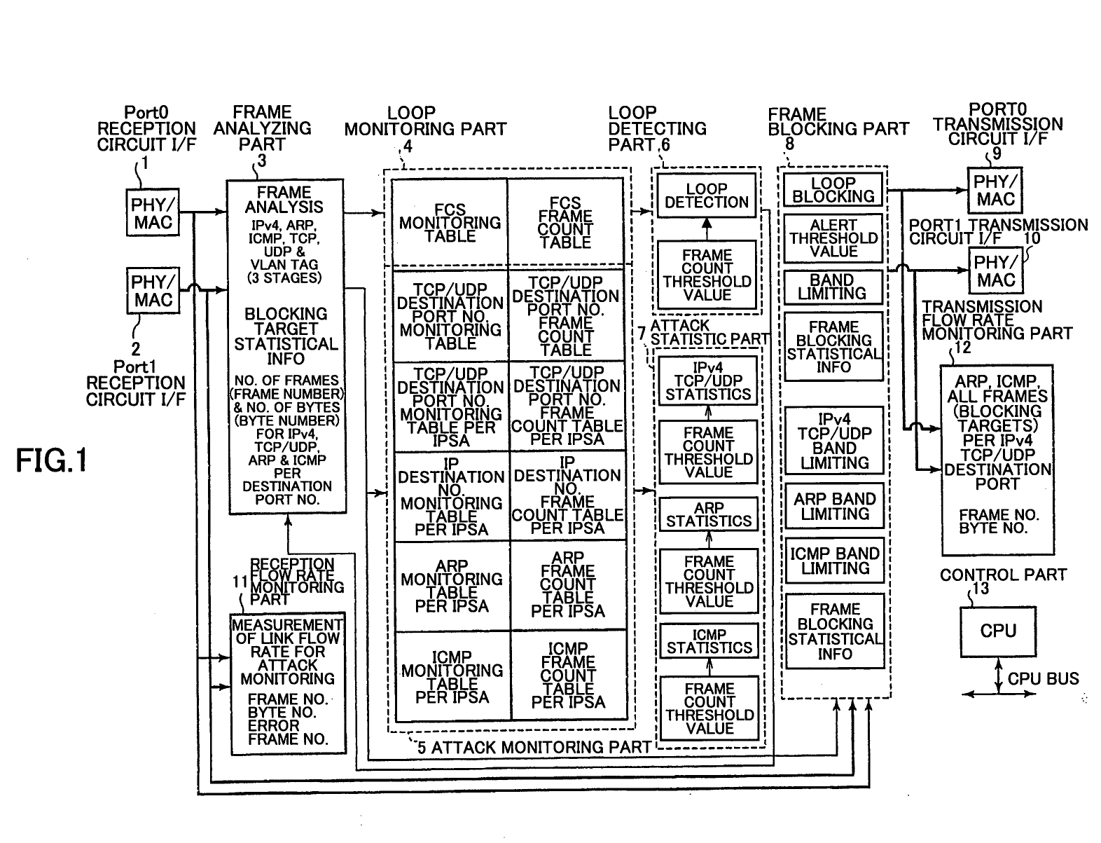

FIG. 1 is a diagram showing an general structure of an embodiment of an abnormal traffic eliminating apparatus according to the present invention. In FIG. 1, a Port0 reception circuit interface (I/F) part 1 forms a reception end line interface with respect to a network that is connected to a first connection terminal Port0, and a Port1 reception circuit I/F part 2 forms a reception end line interface with respect to a network that is connected to a second connection terminal Port1. These reception circuit I/F parts 1 and 2 are respectively formed by a Physical Layer Protocol (PHY) device which mainly carries out a control in a physical layer, and a MAC device which carries out a control in the MAC layer.

A frame analyzing part 3 has the following main functions.
3a) Frame format identification (recognizing whether or not VLAN_Tag exists, and identifying a number of stages when VLAN_Tag exists);
3b) Protocol identification (determining the protocol from IPv4, Address Resolution Protocol (ARP), Internet Control Message Protocol (ICMP), TCP and UDP);
3c) Retrieval keyword extraction (extracting search keywords such as FCS and TCP/UDP destination port number);
3d) Generation of search request to search engine;
3e) Identifying blocking target frames (identifying based on FCS, TCP/UDP destination port number, ARP or ICMP);
3f) Statistical information acquisition including:
   3f-1) Counting number of frames per TCP/UDP destination port number of IPv4 (blocking target);
   3f-2) Counting number of bytes per TCP/UDP destination port number of IPv4 (blocking target);
   3f-3) Counting number of ARP frames (blocking target);
   3f-4) Counting number of bytes of ARP frame (blocking target);
   3f-5) Counting number of ICMP frames (blocking target); and
   3f-6) Counting number of bytes of ICMP frame (blocking target).

A loop monitoring part 4 includes an FCS monitoring table and an FCS frame count table, and has the following main functions.
4a) Carrying out a search with respect to the search engine based on the search keyword (FCS) in response to a search request from the frame analyzing part 3;
4b) Creating an entry by writing a search keyword (FCS) that is a search target into an FCS monitoring table, if a search keyword (FCS) matching the search target does not exist in the FCS monitoring table; and
4c) Counting up a number of counted frames of the search keyword (FCS), if the search keyword (FCS) matching the search target exists in the FCS monitoring table.

An attack monitoring part 5 includes a TCP/UDP destination port number monitoring table, a TCP/UDP destination port number monitoring table per IPSA, an IP destination number monitoring table per IPSA, an ARP monitoring table per IPSA and an ICMP monitoring table per IPSA, and has the following main functions.
5a) Carrying out a search with respect to the search engine based on the search keyword (TCP/UDP destination port number, IP Source Address (IPSA), IP Destination Address (IPDA) or Protocol) in response to the search request from the frame analyzing part 3;
5b) Creating an entry by writing each search keyword within each monitoring table if a matching search keyword does not exist in each monitoring table; and
5c) Counting up a counted number of frames of each entry if a matching search keyword exists within each monitoring table.

A loop detecting part 6 notifies an FCS value of the frame to the frame analyzing part 3 when an entry exceeding a preset threshold value of a loop frame count is detected.

An attack statistic part 7 carries out the following functions based on the frame count number in the attack monitoring part 5.
7a) A frame count is performed with respect to the TCP/UDP destination port numbers of the top 10 frame count numbers extracted from the entry exceeding the threshold value of the frame count for each preset TCP/UDP destination port number;
7b) The IPSA value of the top frame count number for each TCP/UDP destination port number per IPSA is extracted;
7c) An ARP frame count is performed with respect to a top frame count number extracted from the entry exceeding the threshold value of the ARP frame count for each preset IPSA;
7d) The IPSA value of the top ARP frame count number per IPSA is extracted.
7e) An ICMP frame count is performed with respect to a top frame count number extracted from the entry exceeding the threshold value of the ICMP frame count for each preset IPSA; and

7f) The IPSA value of the top ICMP frame count number per IPSA is extracted.

The blocking frame (IPv4, TCP/UDP frame, ARP frame or ICMP frame) is determined based on the above information.

A frame blocking part 8 carries out the following functions based on the frame blocking information from the frame analyzing part 3.
8a) Block all loop frames exceeding an alert threshold value;
8b) Limit the band of the loop frame exceeding the alert threshold value;
8c) Limit the band of IPv4 and TCP/UDP frames (10 frame);
8d) Limit the band of ARP frames;
8e) Limit the band of ICMP frames;
8f) Count the number of blocked loop frames;
8g) Count the number of blocked IPv4 and TCP/UDP frames;
8h) Count the number of blocked ARP frames; and

8i) Count the number of blocked ICMP frames.

A Port0 transmission circuit interface (I/F) part 9 forms a transmission end line interface with respect to the network that is connected to the first connection terminal Port0, and a Port1 transmission circuit I/F part 10 forms a transmission end line interface with respect to the network that is connected to the second connection terminal Port1. These transmission circuit I/F parts 9 and 10 are respectively formed by a PHY device which mainly carries out the control in the physical layer, and a MAC device which carries out the control in the MAC layer.

A reception flow rate monitoring part 11 has a function of measuring the following amounts of traffic in order to measure a flow rate of the link.
11a) Measure the number of received frames;
11b) Measure the number of received bytes; and
11c) Measure the number of received erroneous frames.

A transmission flow rate monitoring part 12 has the following main functions.
12a) Counting number of frames per TCP/UDP destination port number of IPv4 (blocking target);
12b) Counting number of bytes per TCP/UDP destination port number of IPv4 (blocking target);
12c) Counting number of ARP frames (blocking target);
12d) Counting number of bytes of ARP frame (blocking target);
12e) Counting number of ICMP frames (blocking target);
12f) Counting number of bytes of ICMP frame (blocking target);
12g) Counting number of all frames; and

12h) Counting number of bytes of all frames.

A control part 13 is formed by a Central Processing Unit (CPU), for example, and has the functions of controlling the monitoring and control within the abnormal traffic eliminating apparatus and providing an interface with respect to a panel screen from which the abnormal traffic eliminating apparatus is controlled.

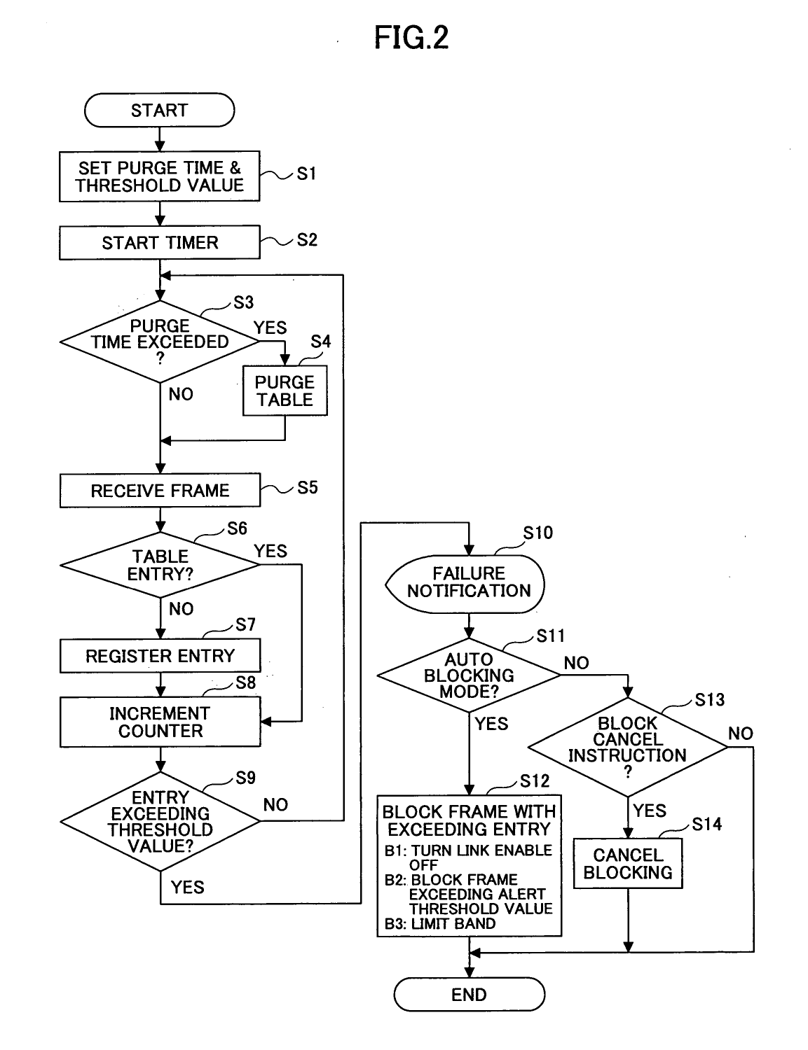

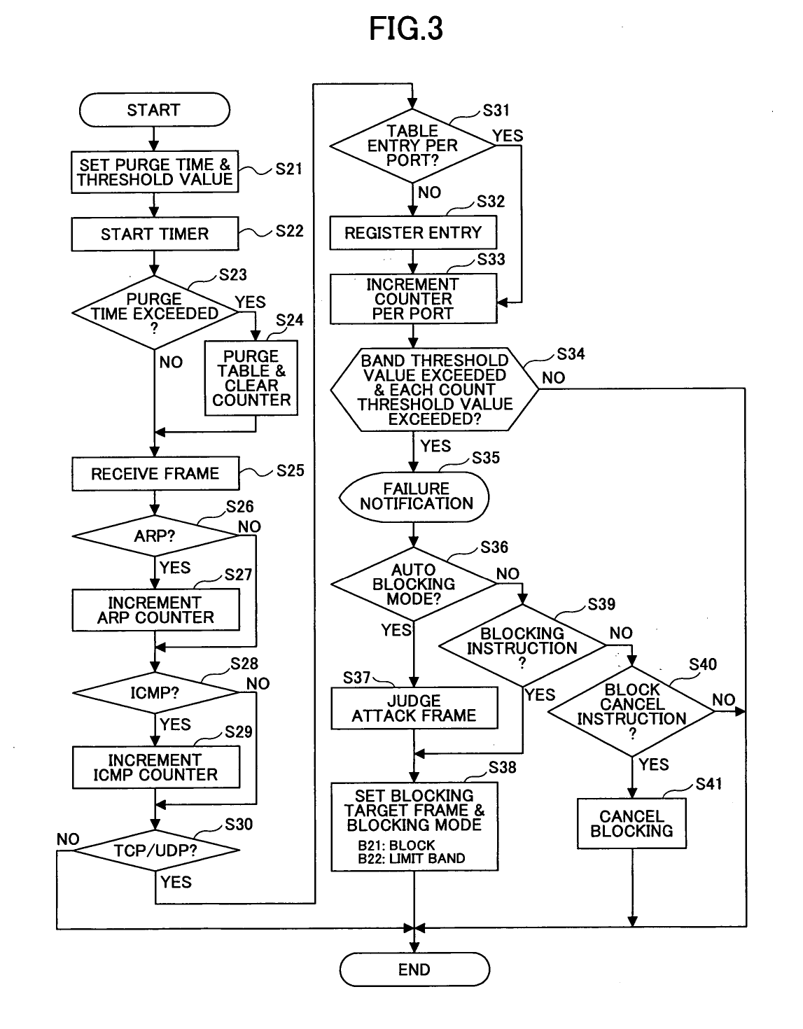

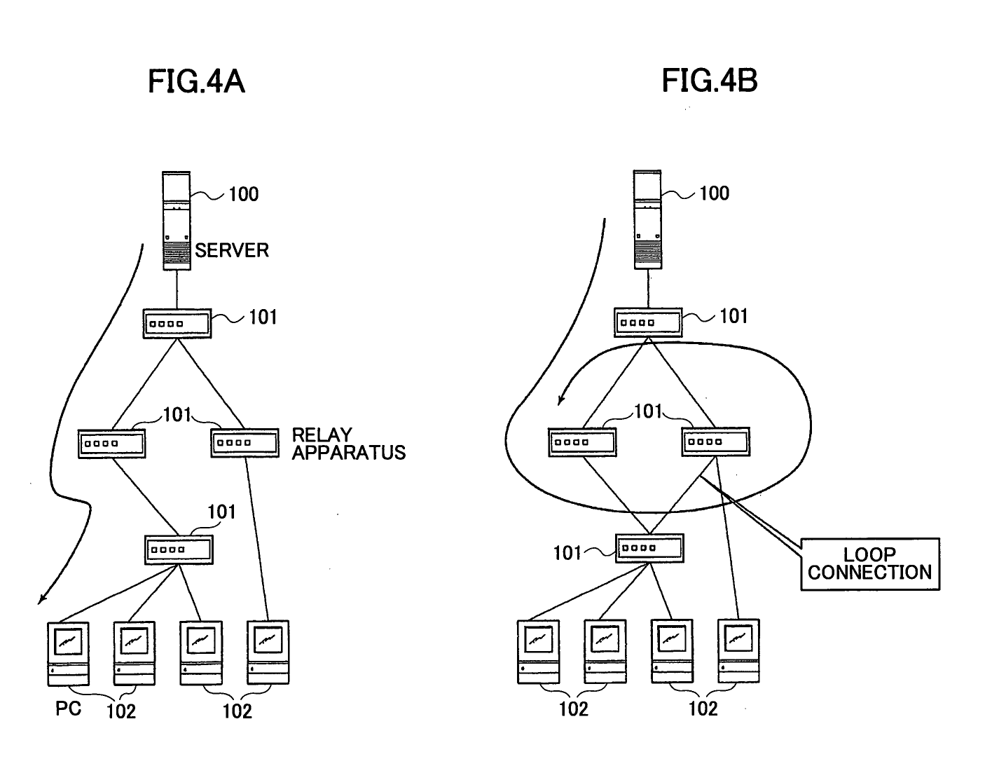

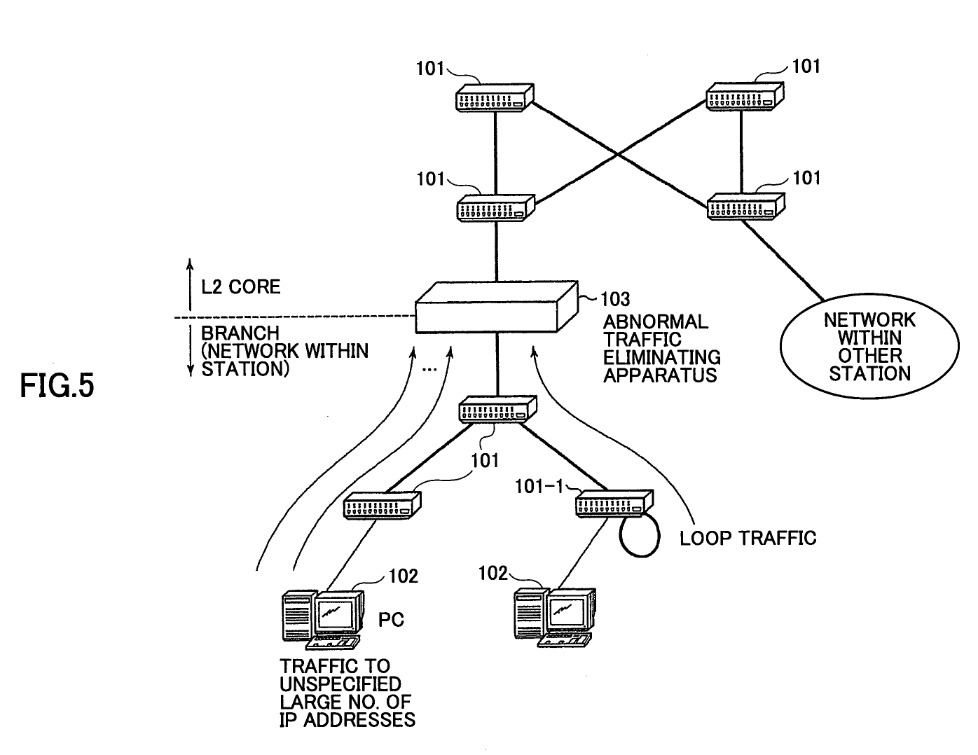

FIG. 2 is a flow chart for explaining a loop eliminating process. FIG. 3 is a flow chart for explaining an attack eliminating process. In addition, FIG. 5 is a diagram for explaining an application an abnormal traffic eliminating apparatus 103 according to this embodiment of the present invention.

When the loop eliminating process shown in FIG. 2 is started, a step S1 sets a purge time and threshold values. The purge time is set to an arbitrary value by an application program (software) in response to an instruction input by an operator (or user) of the abnormal traffic eliminating apparatus. The threshold values may be set in advance or, set by the operator similarly to the purge time. The purge time and the threshold values that are set are stored in one or more registers that are managed by the software. A step S2 starts a software timer within the control part 13 shown in FIG. 1 by the software. A step S3 decides whether or not the purge time is exceeded. More particularly, the software compares the purge time stored in the register and the time measured by the software timer within the control part 13, and judges whether or not the time measured by the software timer has exceeded the purge time.

If the decision result in the step S3 is YES, a step S4 issues a table purge command with respect to the FCS monitoring table within the loop monitoring part 4 shown in FIG. 1 from the software via the control part 13, so as to invalidate all entries of the FCS monitoring table by hardware. On the other hand, if the decision result in the step S3 is NO or after the step S4, a step S5 receives the frame from the line. More particularly, the frame is received by the Port0 reception circuit I/F part 1 or the Port 1 reception circuit I/F part 2 shown in FIG. 1, and the received frame is analyzed in the frame analyzing part 3.

A step S6 decides whether or not an entry exists in the FCS monitoring table within the loop monitoring part 4. More particularly, when a loop search request from the frame analyzing part 3 is received, the loop monitoring part 4 searches the FCS monitoring table, and judges whether or not an entry exists in the FCS monitoring table. The process advances to a step S8 which will be described later if the decision result in the step S6 is YES. If the decision result in the step S6 is NO, a step S7 registers an entry within the FCS monitoring table, and the process advances to the step S8. More particularly, if the search targets in the FCS monitoring table do not match a search keyword (FCS), an entry is created and registered by writing the search keyword (FCS) into the search targets within the FCS monitoring table.

The step S8 increments a frame count of the search keyword (FCS) by the FCS frame count table within the loop monitoring part 4. A step S9 decides whether or not an entry exceeding the threshold value exists. More particularly, the loop detecting part 6 compares the frame count for each entry with the threshold value of the frame count set in the register within the loop detecting part 6, and judges whether or not an entry exceeding the threshold value exists. The process returns to the step S3 if the decision result in the step S9 is NO, so as to return to a frame reception standby state.

If the decision result in the step S9 is YES, a step S10 makes a failure notification, by notifying the generation of a loop frame with respect to the software. A step S11 decides whether or not the automatic blocking mode is instructed. If the decision result in the step S11 is YES, a step S12 automatically carries out a blocking process that is preset by the operator, and the process ends. More particularly, the frame corresponding to the entry exceeding the threshold value is blocked by at least one of the following blocking processes B1 through B3. The blocking process B1 turns the link enable OFF (stops frame transfer) by an autonomous operation of the hardware if the blocking target is an all-pass frame. The blocking process B2 blocks all loop frames exceeding the alert threshold value by an autonomous operation of the hardware if the blocking target is a loop frame and the blocking method blocks the loop frame exceeding the alert threshold value. The blocking process B3 limits the band of the loop frame exceeding the alert threshold value according to a preset pass rate by an autonomous operation of the hardware, if the blocking target is a loop frame and the blocking method limits the band.

On the other hand, the manual blocking mode is instructed if the decision result in the step S11 is NO. A blocking instruction from the operator is judged in the manual blocking mode. Hence, if the blocking instruction from the operator is received, the frame corresponding to the entry exceeding the threshold value is blocked by carrying out a blocking process preset by the operator. The preset blocking process is at least one of the following blocking processes B11 through B13. The blocking process B11 turns the link enable OFF (stops frame transfer) by an intervening operation of the operator if the blocking target is an all-pass frame. The blocking process B12 blocks all loop frames exceeding the alert threshold value by an autonomous operation of the hardware if the blocking target is a loop frame and the blocking method blocks the loop frame exceeding the alert threshold value. The blocking process B13 limits the band of the loop frame exceeding the alert threshold value according to a preset pass rate by an autonomous operation of the hardware, if the blocking target is a loop frame and the blocking method limits the band.

If the decision result in the step S11 is NO, a step S13 decides whether or not a block cancel instruction is received from the operator during the manual blocking mode. The process ends if the decision result in the step S13 is NO. On the other hand, if the decision result in the step S13 is YES, a step S14 cancels the blocking of the loop frame, and the process ends.

When the attack eliminating process shown in FIG. 3 is started, a step S21 sets a purge time and threshold values. The purge time is set to an arbitrary value by an application program (software) in response to an instruction input by an operator (or user) of the abnormal traffic eliminating apparatus. The threshold values may be set in advance or, set by the operator similarly to the purge time. The purge time and the threshold values that are set are stored in one or more registers that are managed by the software. A step S22 starts a software timer within the control part 13 shown in FIG. 1 by the software. A step S23 decides whether or not the purge time is exceeded. More particularly, the software compares the purge time stored in the register and the time measured by the software timer within the control part 13, and judges whether or not the time measured by the software timer has exceeded the purge time.

If the decision result in the step S23 is YES, a step S24 issues a table purge command with respect to the TCP/UDP destination port number monitoring table, the TCP/UDP destination port number monitoring table per IPSA, the IP destination number monitoring table per IPSA, the ARP monitoring table per IPSA and the ICMP monitoring table per IPSA within the attack monitoring part 5 shown in FIG. 1 from the software via the control part 13, so as to invalidate all entries of these 5 monitoring tables and to invalidate (clear) all frame counts by hardware. On the other hand, if the decision result in the step S23 is NO or after the step S24, a step S25 receives the frame from the line. More particularly, the frame is received by the Port0 reception circuit I/F part 1 or the Port 1 reception circuit I/F part 2 shown in FIG. 1, and the received frame is analyzed in the frame analyzing part 3.

A step S26 decides whether or not the received frame is an ARP frame by analyzing the received frame in the frame analyzing part 3. If the decision result in the step S26 is YES, a step S27 searches the ARP monitoring table per IPSA within the attack monitoring part 5, and increments the frame count per IPSA if an entry exists in the ARP monitoring table per IPSA. The frame count per IPSA may be counted by a counter function that is realized by the ARP frame count table per IPSA within the attack monitoring part 5. On the other hand, if no entry exists in the ARP monitoring table per IPSA, an entry is created and registered by writing a search keyword (IPSA) into search targets within the ARP monitoring table per IPSA. The process advances to a step S28 if the decision result in the step S26 is NO or after the step S27.

The step S28 decides whether or not the received frame is an ICMP frame by analyzing the received frame in the frame analyzing part 3. If the decision result in the step S28 is YES, a step S29 searches the ICMP monitoring table per IPSA within the attack monitoring part 5, and increments the frame count per IPSA if an entry exists in the ICMP monitoring table per IPSA. The frame count per IPSA may be counted by a counter function that is realized by the ICMP frame count table per IPSA within the attack monitoring part 5. On the other hand, if no entry exists in the ICMP monitoring table per IPSA, an entry is created and registered by writing a search keyword (IPSA) into search targets within the ICMP monitoring table per IPSA. The process advances to a step S30 if the decision result in the step S28 is NO or after the step S29.

The step S30 decides whether or not the received frame is a TCP/UDP frame by analyzing the received frame in the frame analyzing part 3. The process ends if the decision result in the step S30 is NO. On the other hand, if the decision result in the step S30 is YES, a step S31 decides whether or not a table entry exists for each port with respect to the received TCP/UDP frame. More particularly, the TCP/UDP destination port number monitoring table, the TCP/UDP destination port number monitoring table per IPSA, and the IP destination number monitoring table per IPSA within the attack monitoring part 5 are searched for entries. If the decision result in the step S31 is NO, a step S32 creates and registers and entry by writing a search keyword into search targets within the TCP/UDP destination port number monitoring table, the TCP/UDP destination port number monitoring table per IPSA, and the IP destination number monitoring table per IPSA within the attack monitoring part 5. If the decision result in the step S31 is YES or after the step S32, a step S33 increments the frame count for each of the TCP/UDP destination port number monitoring table, the TCP/UDP destination port number monitoring table per IPSA, and the IP destination number monitoring table per IPSA within the attack monitoring part 5. The frame count may be counted by a counter function that is realized by each of the TCP/UDP destination port number frame count table, the TCP/UDP destination port number frame count table per IPSA, and the IP destination number frame count table per IPSA within the attack monitoring part 5.

A step S34 decides whether or not a threshold value of a link band and a threshold value of each frame count are exceeded. More particularly, the reception flow rate monitoring part 11 compares the link flow rate measured therein with the threshold value of the link band that is preset by the operator to determine whether or not the threshold value of the link band is exceeded, and the attack monitoring part 5 compares each of the frame counts counted by the counter function that is realized by each of the TCP/UDP destination port number frame count table, the TCP/UDP destination port number frame count table per IPSA, the IP destination number frame count table per IPSA, the ARP frame count table per IPSA, and the ICMP frame count table per IPSA within the attack monitoring part 5 with the corresponding threshold value of the frame count that is preset by the operator to determine whether or not the threshold value of the frame count is exceeded. The process ends if the decision result in the step S34 is NO.

On the other hand, if the decision result in the step S34 is YES, a step S35 makes a failure notification, by notifying the generation of an attack with respect to the software. A step S36 decides whether or not the automatic blocking mode is instructed. If the decision result in the step S36 is YES, a step S37 judges the top 10 TCP/UDP destination port numbers having the largest frame counts in the automatic blocking mode, of the frame counts that exceeded the corresponding threshold values in the step S34, and the process advances to a step S38 which will be described later.

The manual blocking mode is instructed if the decision result in the step S36 is NO. A blocking instruction and a block cancel instruction from the operator are judged in the manual blocking mode. If the decision result in the step S36 is NO, a step S39 decides whether or not the blocking instruction is received from the operator during the manual blocking mode. If the decision result in the step S39 is YES, the process advances to the step S38 which will be described later. On the other hand, if the decision result in the step S39 is NO, a step S40 decides whether or not the block cancel instruction is received from the operator during the manual blocking mode. The process ends if the decision result in the step S40 is NO. On the other hand, if the decision result in the step S40 is YES, a step S41 cancels the blocking of the frame, and the process ends.

The step S38 sets the blocking target (frame) to be blocked and sets the blocking mode, and the process ends. In the manual blocking mode, the step S38 displays on the software (that is, displays on a screen managed by the software) the top 10 TCP/UDP destination port numbers having the largest frame counts judged in the step S37 together with the ARP and ICMP frames. Hence, the operator can select the blocking target from the displayed information, to block the blocking target or limit the band of the blocking target. On the other hand, in the automatic blocking mode, the step S38 carries out at least one of the following processes B21 and B22. The process B21 blocks the top 10 TCP/UDP destination port numbers having the largest frame counts judged in the step S37 together with the ARP and ICMP frames. The process B22 limits the band of the top 10 TCP/UDP destination port numbers having the largest frame counts judged in the step S37 together with the ARP and ICMP frames.

Therefore, the FCS value, the TCP/UDP destination port number field or the like is used as the search keyword, and the number of received MAC frames having identical keywords is counted. If the counted number of received MAC frames exceeds a preset threshold value, it is judged that the abnormal traffic is generated due to a loop state of the network or due to an attack with respect to the network. Hence, it is possible to eliminate the abnormal traffic caused by the loop state of the network or the attack with respect to the network, so as to easily avoid the network from becoming unstable and a system failure from occurring, so that a network operation can be continued.

In addition, by displaying the statistical information of the MAC frames having the identical search keywords, it is possible to immediately collect the information for specifying the cause of the abnormal traffic when the abnormal traffic is generated, in the state where the abnormal traffic is generated. As a result, it is possible to immediately cope with the abnormal traffic to appropriately manage the network.

Moreover, it is possible to cope with various network scales and environments, because it is possible to finely set with flexibility the conditions for eliminating the abnormal traffic generated in the network.

### First Embodiment

In this embodiment of the abnormal traffic eliminating apparatus according to the present invention, the monitoring and detecting of the loop are carried out by the following process.

1-1) The validity of the MAC frame is inspected by the Port0 reception circuit I/F part 1 or the Port1 reception circuit I/F part 2, by making an FCS inspection or a frame length inspection. The inspected frame is disposed if defective.

1-2) The frame format is identified in the frame analyzing part 3, and the existence of VLAN_Tag is recognized. If the VLAN_Tag exists, the number of Tag stages is recognized, and a storage location of the FCS is identified. The FCS value is extracted, and a search request to the loop monitoring part 4 using the FCS value as the search keyword is asserted.

1-3) Based on the search request from the frame analyzing part 3, the loop monitoring part 4 carries out a search (or lookup) with respect to the search engine. When a search result is returned from the search engine, the following process is carried out depending on the search result.

1-3a) When the search mishits (search fails): The FCS value is written in the FCS monitoring table, and an entry is newly created. An FCS frame counter which is allocated for each entry within an FCS frame count table is set to “1” (only the first time).

1-3b) When the search hits (search is successful): The FCS frame counter allocated for each entry within the FCS frame count table is incremented (“1” is added to previous value).

1-4) If the value of the FCS frame counter that is monitored when the search hits exceeds the preset threshold value of the frame count, the loop detecting part 6 judges that the network has assumed a loop state and asserts an alarm, and simultaneously notifies the FCS value to the frame analyzing part 3.

According to this embodiment, it is possible to detect a loop traffic in one direction because the frames for the same FCS of the MAC frames received by the plurality of ports can be counted. The conventional method which cannot detect the loop traffic in one direction cannot avoid a network failure, but the problem is eliminated by this embodiment.

### Second Embodiment

The frames are blocked by the following process.

2-1) The MAC frames having the FCS value received from the loop detecting part 6 are identified in the frame analyzing part 3.

2-2) A flag is added to each MAC frame when the MAC frames are identified, and the MAC frames (added with the flag) are sent to the frame blocking part 8.

2-3) The MAC frames are blocked by the frame blocking part 8 according to a preset blocking method, such as blocking or limiting a band of the MAC frames exceeding the alert threshold value.

According to this embodiment, it is possible to detect the loop state of the network from the MAC frames received by the plurality of ports, and eliminate the abnormal traffic. Hence, it is possible to eliminate the loop in one direction, and avoid the network failure.

### Third Embodiment

The following process is carried out in an automatic blocking mode for automatically blocking the loop frame.

3-1) If the blocking target is an all-pass frame, the hardware of the abnormal traffic eliminating apparatus turns the link enable OFF (that is, stops the frame transfer) by autonomous control.

3-2) If the blocking target is a loop frame and the blocking method is “block frame exceeding the alert threshold value”, all loop frames exceeding the alert threshold value are blocked.

3-3) If the blocking target is a loop frame and the blocking method is “limit the band”, the band of the loop frame exceeding the alert threshold value is limited according to a preset pass rate.

The following process is carried out in a manual blocking mode for manually blocking the loop frame.

3-11) If the blocking target is an all-pass frame, an operator of the abnormal traffic eliminating apparatus turns the link enable OFF (that is, stops the frame transfer) by manual control.

3-12) If the blocking target is a loop frame and the blocking method is “block frame exceeding the alert threshold value”, all loop frames exceeding the alert threshold value are blocked (by autonomous control of the hardware).

3-13) If the blocking target is a loop frame and the blocking method is “limit the band”, the band of the loop frame exceeding the alert threshold value is limited according to a preset pass rate (by autonomous control of the hardware).

According to this embodiment, it is possible to select an appropriate method of eliminating the MAC frames received by the plurality of ports (that is, a blocking mode), from the automatic blocking mode and the manual blocking mode, to suit the needs.

### Fourth Embodiment

The following process is carried out if the blocking target is the all-pass frame.

4-1) If the blocking mode is the automatic blocking mode, the hardware of the abnormal traffic eliminating apparatus turns the link enable OFF (that is, stops the frame transfer) by autonomous control.

4-2) If the blocking mode is the manual blocking mode, the operator of the abnormal traffic eliminating apparatus turns the link enable OFF (that is, stops the frame transfer) by manual control.

The following process is carried out if the blocking target is the loop frame.

4-11) If the blocking method is “block frame exceeding the alert threshold value”, all loop frames exceeding the alert threshold value are blocked.

4-12) If the blocking method is “limit the band”, the band of the loop frame exceeding the alert threshold value is limited according to the preset pass rate.

According to this embodiment, of the MAC frames received by the plurality of ports, the target frames to be eliminated can be selected from all of the frames passing within the abnormal traffic eliminating apparatus and the frames that are detected as being loop frames. As a result, it is possible to eliminate the frames depending on the state of the network.

### Fifth Embodiment

The blocking of the loop frame exceeding the alert threshold value is carried out by the following process.

5-1) The validity of the MAC frame is inspected by an FCS inspection or a frame length inspection, for example, in the Port0 reception circuit I/F part 1 or the Port1 reception circuit I/F part 2. The inspected frame is disposed if defective as a result of the inspection.

5-2) The frame format is identified in the frame analyzing part 3, and the existence of VLAN_Tag is recognized. If the VLAN_Tag exists, the number of Tag stages is recognized, and the storage location of the FCS is identified. The FCS value is extracted, and the search request to the loop monitoring part 4 using the FCS value as the search keyword is asserted.

5-3) Based on the search request from the frame analyzing part 3, the loop monitoring part 4 carries out the search (or lookup) with respect to the search engine. When the search result is returned from the search engine, the following process is carried out depending on the search result.

5-3a) When the search mishits (search fails): The FCS value is written in the FCS monitoring table, and the entry is newly created. The FCS frame counter which is allocated for each entry within the FCS frame count table is set to “1” (only the first time).

5-3b) When the search hits (search is successful): The FCS frame counter allocated for each entry within the FCS frame count table is incremented (“1” is added to previous value).

5-4) If the value of the FCS frame counter that is monitored when the search hits exceeds the preset threshold value of the frame count, the loop detecting part 6 judges that the network has assumed the loop state and asserts the alarm, and simultaneously notifies the FCS value to the frame analyzing part 3.

5-5) The MAC frame having the FCS value received from the loop detecting part 6 is identified in the frame analyzing part 3.

5-6) When the MAC frame having the received FCS value is identified by the frame analyzing part 3, the flag is added to the MAC frame and this MAC frame which is added with the flag is sent to the frame blocking part 8.

5-7) All of the MAC frames added with the flag are blocked by the frame blocking part 8.

According to this embodiment, it is judged that the loop abnormality is generated at the point in time or after the frame count of the MAC frames received by the plurality of ports exceeds the threshold value of the frame count, and the loop frame is blocked thereafter. For this reason, a normal frame will not be eliminated, and only the loop frame will be blocked.

### Sixth Embodiment

The limiting of the band of the loop frame is carried out by the following process.

6-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

6-2) The frame format is identified in the frame analyzing part 3, and the existence of VLAN_Tag is recognized. If the VLAN_Tag exists, the number of Tag stages is recognized, and the storage location of the FCS is identified. The FCS value is extracted, and the search request to the loop monitoring part 4 using the FCS value as the search keyword is asserted.

6-3) Based on the search request from the frame analyzing part 3, the loop monitoring part 4 carries out the search (or lookup) with respect to the search engine. When the search result is returned from the search engine, the following process is carried out depending on the search result.

6-3a) When the search mishits (search fails): The FCS value is written in the FCS monitoring table, and the entry is newly created. The FCS frame counter which is allocated for each entry within the FCS frame count table is set to “1” (only the first time).

6-3b) When the search hits (search is successful): The FCS frame counter allocated for each entry within the FCS frame count table is incremented (“1” is added to previous value).

6-4) If the value of the FCS frame counter that is monitored when the search hits exceeds the preset threshold value of the frame count, the loop detecting part 6 judges that the network has assumed the loop state and asserts the alarm, and simultaneously notifies the FCS value to the frame analyzing part 3.

6-5) The MAC frame having the FCS value received from the loop detecting part 6 is identified in the frame analyzing part 3.

6-6) When the MAC frame having the received FCS value is identified by the frame analyzing part 3, the flag is added to the MAC frame and this MAC frame which is added with the flag is sent to the frame blocking part 8.

6-7) The MAC frames added with the flag are passed by the frame blocking part 8 only at the preset pass rate.

According to this embodiment, it is judged that the loop abnormality is generated at the point in time or after the frame count of the MAC frames received by the plurality of ports exceeds the threshold value of the frame count, and the loop frame is blocked thereafter. For this reason, a normal frame will not be eliminated, and only the band of the loop frame will be limited.

### Seventh Embodiment

The display of statistical information of the loop frame can be carried out by the following process.

7-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

7-2) The frame format is identified in the frame analyzing part 3, and the existence of VLAN_Tag is recognized. If the VLAN_Tag exists, the number of Tag stages is recognized, and the storage location of the FCS is identified. The FCS value is extracted, and the search request to the loop monitoring part 4 using the FCS value as the search keyword is asserted.

7-3) Based on the search request from the frame analyzing part 3, the loop monitoring part 4 carries out the search (or lookup) with respect to the search engine. When the search result is returned from the search engine, the following process is carried out depending on the search result.

7-3a) When the search mishits (search fails): The FCS value is written in the FCS monitoring table, and the entry is newly created. The FCS frame counter which is allocated for each entry within the FCS frame count table is set to “1” (only the first time).

7-3b) When the search hits (search is successful): The FCS frame counter allocated for each entry within the FCS frame count table is incremented (“1” is added to previous value).

7-4) If the value of the FCS frame counter that is monitored when the search hits exceeds the preset threshold value of the frame count, the loop detecting part 6 accumulates the number of entries, and returns the value depending on a read request from the control part 13. The control part 13 displays the received value on a software (operable in a general purpose computer) which controls the abnormal traffic eliminating apparatus.

7-5) If the value of the FCS frame counter that is monitored when the search hits exceeds the preset threshold value of the frame count, the loop detecting part 6 accumulates the number of frames for each entry, and returns the value depending on the read request from the control part 13. The control part 13 displays the received value on the software (operable in a general purpose computer) which controls the abnormal traffic eliminating apparatus.

7-6) If the value of the FCS frame counter that is monitored when the search hits exceeds the preset threshold value of the frame count, the loop detecting part 6 accumulates the sum total of the number of frames for the entries exceeding the threshold value, and returns the value depending on the read request from the control part 13. The control part 13 displays the received value on the software (operable in a general purpose computer) which controls the abnormal traffic eliminating apparatus.

According to this embodiment, it is possible to restore the network by identifying the cause of the loop abnormality state that is generated, from the statistical information of the looped MAC frames. Hence, it is possible to avoid the network failure which would otherwise greatly affect the network.

### Eighth Embodiment

The monitoring and detecting of the attack can be carried out by the following process.

8-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

8-2) The number of frames received, the number of bytes received and the number of erroneous frames received by each of the connection terminals Port0 and Port1 are measured by the reception flow rate monitoring part 11.

8-3) When the values measured by the reception flow rate monitoring part 11 are monitored and the flow rate of the frames exceeds a monitoring threshold value, it is judged that an attack was made if the number of frames measured by any one of the ninth through thirteenth embodiments described hereunder exceeds a preset threshold value.

According to this embodiment, it is possible to instantaneously judge that the attack was made by monitoring the link band (traffic flow rate).

### Ninth Embodiment

The statistics for each attacked TCP/UDP destination port number are processed as follows.

9-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

9-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the TCP/UDP destination port number is identified. The TCP/UDP destination port number is extracted, and a search request to the attack monitoring part 5 using the TCP/UDP destination port number as the search keyword is asserted.

9-3) Based on the search request from the frame analyzing part 3, the attack monitoring part 5 carries out the search (or lookup) with respect to the search engine. When the search result is returned from the search engine, the following process is carried out depending on the search result.

9-3a) When the search mishits (search fails): The TCP/UDP destination port number is written in a TCP/UDP destination port number monitoring table, and an entry is newly created. A TCP/UDP destination port number frame counter which is allocated for each entry within the TCP/UDP destination port number frame count table is set to “1” (only the first time).

9-3b) When the search hits (search is successful): The TCP/UDP destination port number frame counter allocated for each entry within the TCP/UDP destination port number frame count table is incremented (“1” is added to previous value).

According to this embodiment, it is possible to identify the cause of the generated attack by the IPv4 frame, from the frame count of the IPv4 frames for each TCP/UDP destination number.

### Tenth Embodiment

The statistics for each TCP/UDP destination port number per attacking IPSA are processed as follows.

10-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

10-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the TCP/UDP destination port number is identified, and the location of the Protocol field is identified. The location of the IPSA is identified. The TCP/UDP destination port number, the Protocol field and the IPSA are extracted, and a search request to the attack monitoring part 5 using the TCP/UDP destination port number, the Protocol field and the IPSA as the search keywords is asserted.

10-3) Based on the search request from the frame analyzing part 3, the attack monitoring part 5 carries out the search (or lookup) with respect to the search engine. When the search result is returned from the search engine, the following process is carried out depending on the search result.

10-3a) When the search mishits (search fails): The TCP/UDP destination port number, the Protocol field and the IPSA value are written in a TCP/UDP destination port number monitoring table per IPSA, and an entry is newly created. A TCP/UDP destination port number frame counter per IPSA, which is allocated for each entry within the TCP/UDP destination port number frame count table per IPSA, is set to “1” (only the first time).

10-3b) When the search hits (search is successful): The TCP/UDP destination port number frame counter per IPSA, allocated for each entry within the TCP/UDP destination port number frame count table per IPSA, is incremented (“1” is added to previous value).

According to this embodiment, it is possible to identify the cause of the generated attack by the IPv4 frame, from the frame count of the IPv4 frames for each TCP/UDP destination number per IPSA.

### Eleventh Embodiment

The statistics for the IP destination number per attacking IPSA are processed as follows.

11-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

11-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the IPDA is identified, and the location of the IPSA is identified. The IPDA and the IPSA are extracted, and a search request to the attack monitoring part 5 using the IPDA and the IPSA as the search keywords is asserted.

11-3) Based on the search request from the frame analyzing part 3, the attack monitoring part 5 carries out the search (or lookup) with respect to the search engine. When the search result is returned from the search engine, the following process is carried out depending on the search result.

11-3a) When the search mishits (search fails): The IPDA and IPSA values are written in an IP destination number monitoring table per IPSA, and an entry is newly created. An IP destination number frame counter per IPSA, which is allocated for each entry within the IP destination number frame count table per IPSA, is set to “1” (only the first time).

11-3b) When the search hits (search is successful): The IP destination number frame counter per IPSA, allocated for each entry within the IP destination number frame count table per IPSA, is incremented (“1” is added to previous value).

According to this embodiment, it is possible to identify the cause of the generated attack by the IPv4 frame, from the frame count of the IPv4 frames for each IP destination number per IPSA.

### Twelfth Embodiment

The statistics for the ARP frame number per attacking IPSA are processed as follows.

12-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

12-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the IPSA is identified. The IPSA is extracted, and a search request to the attack monitoring part 5 using the IPSA as the search keyword is asserted.

12-3) Based on the search request from the frame analyzing part 3, the attack monitoring part 5 carries out the search (or lookup) with respect to the search engine. When the search result is returned from the search engine, the following process is carried out depending on the search result.

12-3a) When the search mishits (search fails): The IPSA value is written in an ARP frame number monitoring table per IPSA, and an entry is newly created. An ARP frame counter per IPSA, which is allocated for each entry within the ARP frame count table per IPSA, is set to “1” (only the first time).

12-3b) When the search hits (search is successful): The ARP frame counter per IPSA, allocated for each entry within the ARP frame count table per IPSA, is incremented (“1” is added to previous value).

According to this embodiment, it is possible to identify the cause of the generated attack by the ARP frame, from the frame count of the ARP frames per IPSA.

### Thirteenth Embodiment

The statistics for the ICMP frame number per attacking IPSA are processed as follows.

13-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

13-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the IPSA is identified. The IPSA is extracted, and a search request to the attack monitoring part 5 using the IPSA as the search keyword is asserted.

13-3) Based on the search request from the frame analyzing part 3, the attack monitoring part 5 carries out the search (or lookup) with respect to the search engine. When the search result is returned from the search engine, the following process is carried out depending on the search result.

13-3a) When the search mishits (search fails): The IPSA value is written in an ICMP frame number monitoring table per IPSA, and an entry is newly created. An ICMP frame counter per IPSA, which is allocated for each entry within the ICMP frame count table per IPSA, is set to “1” (only the first time).

13-3b) When the search hits (search is successful): The ICMP frame counter per IPSA, allocated for each entry within the ICMP frame count table per IPSA, is incremented (“1” is added to previous value).

According to this embodiment, it is possible to identify the cause of the generated attack by the ICMP frame, from the frame count of the ICMP frames per IPSA.

### Fourteenth Embodiment

The statistics for the attacking IPv4 frames are processed as follows.

14-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

14-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the TCP/UDP destination port number is identified. The TCP/UDP destination port number is extracted, and a search request to the attack monitoring part 5 using the TCP/UDP destination port number as the search keyword is asserted.

14-3) Based on the search request from the frame analyzing part 3, the attack monitoring part 5 carries out the search (or lookup) with respect to the search engine. When the search result is returned from the search engine, the following process is carried out depending on the search result.

14-3a) When the search mishits (search fails): The value of the TCP/UDP destination port number is written in the TCP/UDP destination number monitoring table, and an entry is newly created. The TCP/UDP destination number frame counter which is allocated for each entry within the TCP/UDP destination number frame count table is set to “1” (only the first time).

14-3b) When the search hits (search is successful): The TCP/UDP destination number frame counter allocated for each entry within the TCP/UDP destination number frame count table is incremented (“1” is added to previous value).

14-4) If an IPv4 TCP/UDP statistic part within the attack statistic part 7 detects that the value of the frame counter for each TCP/UDP destination port number monitored when the search hits exceeds a preset threshold value of the frame count, the top 10 TCP/UDP destination port numbers having the larger frame counts exceeding the threshold value are extracted from the TCP/UDP destination port number monitoring table within the attack monitoring part 5 and transferred to a register within the attack statistic part 7.

14-5) The frame count for each of the extracted top 10 TCP/UDP destination port numbers is extracted from the TCP/UDP destination port number frame count table within the attack monitoring part 5, and the frame count is continued in an IPv4 TCP/UDP statistic part within the attack statistic part 7. The frame count operation is carried out using the register within the attack statistic part 7.

14-6) The value of the IPSA having the largest count value is extracted from the TCP/UDP destination port number monitoring table per IPSA within the attack monitoring part 5 and transferred to the register within the attack statistic part 7, for each of the extracted top 10 TCP/UDP destination port numbers.

According to this embodiment, it is possible to obtain the frame statistic information for each TCP/UDP destination port number with respect to the attack by the IPv4 TCP/UDP frame, from the frame count of the IPv4 frames for each TCP/UDP destination port number.

### Fifteenth Embodiment

The statistics for the ARP frames are processed as follows.

15-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

15-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the IPSA is identified. The IPSA is extracted, and a search request to the attack monitoring part 5 using the IPSA as the search keyword is asserted.

15-3) Based on the search request from the frame analyzing part 3, the attack monitoring part 5 carries out the search (or lookup) with respect to the search engine. When the search result is returned from the search engine, the following process is carried out depending on the search result.

15-3a) When the search mishits (search fails): The value of the IPSA is written in the ARP frame number monitoring table per IPSA, and an entry is newly created. The ARP frame counter per IPSA, which is allocated for each entry within the ARP frame count table per IPSA, is set to “1” (only the first time).

15-3b) When the search hits (search is successful): The ARP frame counter per IPSA, allocated for each entry within the ARP frame count table per IPSA, is incremented (“1” is added to previous value).

15-4) An ARP statistic part within the attack statistic part 7 detects a threshold exceeded state when the value of the ARP frame counter per IPSA, monitored when the search hits, exceeds a preset threshold value of the frame count.

15-5) The ARP frame count per IPSA is extracted from the ARP frame count table per IPSA within the attack monitoring part 5 when the threshold exceeded state is detected, and the frame count is continued in the ARP statistic part within the attack statistic part 7. The frame count operation is carried out using the register within the attack statistic part 7.

15-6) The value of the IPSA having the largest count value for the ARP frame count per IPSA is extracted from the ARP monitoring table per IPSA within the attack monitoring part 5 and transferred to the register within the attack statistic part 7.

According to this embodiment, it is possible to obtain the frame statistic information for each IPSA with respect to the attack by the IPv4 ARP frame, from the frame count of the ARP frames for each IPSA.

### Sixteenth Embodiment

The statistics for the ICMP frames are processed as follows.

16-1) The validity of the MAC frame is inspected by the FCS inspection or the frame length inspection, for example, in the Port0 reception circuit I/F part 1 or the Port1 reception circuit I/F part 2. The inspected frame is disposed if defective as a result of the inspection.

16-2) The frame format is identified in the frame analyzing part 3, and the existence of VLAN_Tag is recognized. If the VLAN_Tag exists, the number of Tag stages is recognized. The frame is recognized by identifying the protocol such as IPv4, ARP, ICMP, TCP and UDP. In addition, the location of the IPSA is identified. The IPSA is extracted, and a search request to the attack monitoring part 5 using the IPSA as the search keyword is asserted.

16-3) Based on the search request from the frame analyzing part 3, the attack monitoring part 5 carries out the search (or lookup) with respect to the search engine. When the search result is returned from the search engine, the following process is carried out depending on the search result.

16-3a) When the search mishits (search fails): The value of the IPSA is written in the ICMP frame number monitoring table per IPSA, and an entry is newly created. The ICMP frame counter per IPSA, which is allocated for each entry within the ICMP frame count table per IPSA, is set to “1” (only the first time).

16-3b) When the search hits (search is successful): The ICMP frame counter per IPSA, allocated for each entry within the ICMP frame count table per IPSA, is incremented (“1” is added to previous value).

16-4) An ICMP statistic part within the attack statistic part 7 detects a threshold exceeded state when the value of the ICMP frame counter per IPSA, monitored when the search hits, exceeds a preset threshold value of the frame count.

16-5) The ICMP frame count per IPSA is extracted from the ICMP frame count table per IPSA within the attack monitoring part 5 when the threshold exceeded state is detected, and the frame count is continued in the ICMP statistic part within the attack statistic part 7. The frame count operation is carried out using the register within the attack statistic part 7.

16-6) The value of the IPSA having the largest count value for the ICMP frame count per IPSA is extracted from the ICMP monitoring table per IPSA within the attack monitoring part 5 and transferred to the register within the attack statistic part 7.

According to this embodiment, it is possible to obtain the frame statistic information for each IPSA with respect to the attack by the IPv4 ICMP frame, from the frame count of the ICMP frames for each IPSA.

### Seventeenth Embodiment

The process to determine the blocking target is carried out as follows with respect to the attacking IPv4 frame.

17-1) The TCP/UDP destination port number of the blocking target is determined based on the top 10 TCP/UDP destination port numbers extracted by the step 14-4) of the fourteenth embodiment described above and the frame count (continued count) for each of the top 10 TCP/UDP destination port numbers extracted by the step 14-5) of the fourteenth embodiment.

According to this embodiment, it is possible to identify the frame (TCP/UDP destination port number) that is the blocking target with respect to the attack by the IPv4 TCP/UDP frame, based on the frame count of the IPv4 frames for each TCP/UDP destination port number.

### Eighteenth Embodiment

The process to determine the pass rate of the attacking IPv4 frames is carried out as follows.

18-1) The number of received frames, the number of received bytes and the link flow rate are analyzed for each TCP/UDP destination port number which is determined as being the blocking target in the seventeenth embodiment described above, so as to determine the frame pass rate per TCP/UDP destination port number.

According to this embodiment, it is possible to set the pass rate of the frame (TCP/UDP destination port number) that becomes the blocking target with respect to the attack by the IPv4 TCP/UDP frame, based on the frame count of the IPv4 frames for each TCP/UDP destination port number.

### Nineteenth Embodiment

The process to limit the band of the attacking IPv4 frame is carried out as follows.

19-1) The pass rate of the frame for each TCP/UDP destination port number determined in the eighteenth embodiment described above is set in a register within the frame blocking part 8 associated with limiting the band of IPv4 and TCP/UDP frames.

19-2) Since a valid bit is added to the pass rate for each TCP/UDP destination port number, the valid bit is turned ON when validating and executing the pass rate.

19-3) When the pass rate is validated, the number of received bytes of the frame having the target TCP/UDP destination port number are counted. The band is limited by not receiving the frames after the number of bytes set as the pass rate are counted within a certain time (for example, 100 ms).

According to this embodiment, it is possible to limit the band of the attacking frames of the IPv4 frames, by counting the IPv4 frames for each TCP/UDP destination port number, and passing the frames at the pass rate of the frames (TCP/UDP destination port numbers) that become the blocking target with respect to the attack by the IPv4 TCP/UDP frames.

### Twentieth Embodiment

The process to determine the blocking target is carried out as follows with respect to the attacking ARP frame.

20-1) The ARP frame that is the blocking target is determined based on the ARP frame count (continued count) per IPSA extracted by the step 15-5) of the fifteenth embodiment.

According to this embodiment, it is possible to identify the ARP frame that is the blocking target with respect to the attack by the IPv4 ARP frame, based on the frame count of the IPv4 ARP frames.

### Twenty-First Embodiment

The process to determine the pass rate of the attacking ARP frames is carried out as follows.

21-1) The number of received frames, the number of received bytes and the link flow rate are analyzed for the ARP frame when the ARP frame is determined as being the blocking target in the twentieth embodiment described above, so as to determine the ARP frame pass rate.

According to this embodiment, it is possible to set the pass rate of the ARP frame that becomes the blocking target with respect to the attack by the IPv4 ARP frame, based on the frame count of the IPv4 ARP frames.

### Twenty-Second Embodiment

The process to limit the band of the attacking ARP frame is carried out as follows.

22-1) The pass rate of the ARP frame determined in the twenty-first embodiment described above is set in the register within the frame blocking part 8 associated with limiting the band of IPv4 and: TCP/UDP frames.

22-2) Since a valid bit is added to the pass rate of the ARP frame, the valid bit is turned ON when validating and executing the pass rate.

22-3) When the pass rate is validated, the number of received bytes of the ARP frame are counted. The band is limited by not receiving the frames after the number of bytes set as the pass rate are counted within a certain time (for example, 100 ms).

According to this embodiment, it is possible to limit the band of the attacking frames of the ARP frames, by counting the IPv4 ARP frames, and passing the frames at the pass rate of the ARP frame that becomes the blocking target with respect to the attack by the IPv4 ARP frames.

### Twenty-Third Embodiment

The process to determine the blocking target is carried out as follows with respect to the attacking ICMP frame.

23-1) The ICMP frame that is the blocking target is determined based on the ICMP frame count (continued count) per IPSA extracted by the step 16-5) of the sixteenth embodiment.

According to this embodiment, it is possible to identify the ICMP frame that is the blocking target with respect to the attack by the IPv4 ICMP frame, based on the frame count of the IPv4 ICMP frames.

### Twenty-Fourth Embodiment

The process to determine the pass rate of the attacking ICMP frames is carried out as follows.

24-1) The number of received frames, the number of received bytes and the link flow rate are analyzed for the ICMP frame when the ICMP frame is determined as being the blocking target in the twenty-third embodiment described above, so as to determine the ICMP frame pass rate.

According to this embodiment, it is possible to set the pass rate of the ICMP frame that becomes the blocking target with respect to the attack by the IPv4 ICMP frame, based on the frame count of the IPv4 ICMP frames.

### Twenty-Fifth Embodiment

The process to limit the band of the attacking ICMP frame is carried out as follows.

25-1) The pass rate of the ICMP frame determined in the twenty-fourth embodiment described above is set in the register within the frame blocking part 8 associated with limiting the band of IPv4 and TCP/UDP frames.

25-2) Since a valid bit is added to the pass rate of the ICMP frame, the valid bit is turned ON when validating and executing the pass rate.

25-3) When the pass rate is validated, the number of received bytes of the ICMP frame are counted. The band is limited by not receiving the frames after the number of bytes set as the pass rate are counted within a certain time (for example, 100 ms).

According to this embodiment, it is possible to limit the band of the attacking frames of the ICMP frames, by counting the IPv4 ICMP frames, and passing the frames at the pass rate of the ICMP frame that becomes the blocking target with respect to the attack by the IPv4 ICMP frames.

### Twenty-sixth Embodiment

The display of the cause of the attack (hereinafter simply referred to as the “attack cause”) of the attacking IPv4 frame is carried out by the following process.

26-1) The IPSA value having the largest count value for each of the top 10 TCP/UDP destination port numbers extracted by the step 14-6) of the fourteenth embodiment described above is returned in response to a read request from the control part 13.

26-2) The controller 13 displays the received value on the software (operable in a general purpose computer) which controls the abnormal traffic eliminating apparatus.

26-3) The operator of the abnormal traffic eliminating apparatus identifies, from the displayed IPSA value, the IP transmitting source address that is transmitting the attacking IPv4 frame, so that it is possible to immediately collect information for identifying the attack cause.

According to this embodiment, it is possible to identify a new attack cause that cannot be identified by the conventional method which predicts the attack pattern (IP address, protocol type or TCP/UDP port number) in advance, by analyzing the extracted IPSA information and displaying the attack source of the attacking IPv4 TCP/UDP frame, with respect to the attack by the IPv4 TCP/UDP frame.

### Twenty-Seventh Embodiment

The display of the attack cause of the attacking ARP frame is carried out by the following process.

27-1) The IPSA value having the largest count value and extracted by the step 15-6) of the fifteenth embodiment described above is returned in response to a read request from the control part 13.

27-2) The controller 13 displays the received value on the software (operable in a general purpose computer) which controls the abnormal traffic eliminating apparatus.

27-3) The operator of the abnormal traffic eliminating apparatus identifies, from the displayed IPSA value, the IP transmitting source address that is transmitting the attacking ARP frame, so that it is possible to immediately collect information for identifying the attack cause.

According to this embodiment, it is possible to identify a new attack cause that cannot be identified by the conventional method which predicts the attack pattern (IP address, protocol type or TCP/UDP port number) in advance, by analyzing the extracted IPSA information and displaying the attack source of the attacking IPv4 ARP frame, with respect to the attack by the IPv4 ARP frame.

### Twenty-Eighth Embodiment

The display of the attack cause of the attacking ICMP frame is carried out by the following process.

28-1) The IPSA value having the largest count value and extracted by the step 16-6) of the sixteenth embodiment described above is returned in response to a read request from the control part 13.

28-2) The controller 13 displays the received value on the software (operable in a general purpose computer) which controls the abnormal traffic eliminating apparatus.

28-3) The operator of the abnormal traffic eliminating apparatus identifies, from the displayed IPSA value, the IP transmitting source address that is transmitting the attacking ICMP frame, so that it is possible to immediately collect information for identifying the attack cause.

According to this embodiment, it is possible to identify a new attack cause that cannot be identified by the conventional method which predicts the attack pattern (IP address, protocol type or TCP/UDP port number) in advance, by analyzing the extracted IPSA information and displaying the attack source of the attacking IPv4 ICMP frame, with respect to the attack by the IPv4 ICMP frame.

### Twenty-Ninth Embodiment

The process with respect to the attacking frame in the automatic blocking mode is carried out as follows.

29-1) The process of the nineteenth embodiment described above is carried out with respect to the IPv4 TCP/UDP frame by the autonomous processing function of the hardware or software.

29-2) The process of the twenty-second embodiment described above is carried out with respect to the ARP frame by the autonomous processing function of the hardware or software.

29-3) The process of the twenty-fifth embodiment described above is carried out with respect to the ICMP frame by the autonomous processing function of the hardware or software.

The process with respect to the attacking frame in the manual blocking mode is carried out as follows.

29-11) The step 19-1) of the nineteenth embodiment described above is carried out with respect to the IPv4 TCP/UDP frame by the autonomous processing function of the hardware. The step 19-2) of the nineteenth embodiment is carried out by the intervention of the operator who controls the abnormal traffic eliminating apparatus to make the ON or OFF setting with respect to the valid bit that is added to the pass rate for each TCP/UDP destination port number. The step 19-3) of the nineteenth embodiment is carried out by the autonomous processing function of the hardware.

29-12) The step 22-1) of the twenty-second embodiment described above is carried out with respect to the ARP frame by the autonomous processing function of the hardware. The step 22-2) of the twenty-second embodiment is carried out by the intervention of the operator who controls the abnormal traffic eliminating apparatus to make the ON or OFF setting with respect to the valid bit that is added to the pass rate for each ARP frame. The step 22-3) of the twenty-second embodiment is carried out by the autonomous processing function of the hardware.

29-13) The step 25-1) of the twenty-fifth embodiment described above is carried out with respect to the ICMP frame by the autonomous processing function of the hardware. The step 25-2) of the twenty-fifth embodiment is carried out by the intervention of the operator who controls the abnormal traffic eliminating apparatus to make the ON or OFF setting with respect to the valid bit that is added to the pass rate for each ICMP frame. The step 25-3) of the twenty-fifth embodiment is carried out by the autonomous processing function of the hardware.

According to this embodiment, the attacking frame received by the plurality of ports can be eliminated by the automatic blocking mode or the manual blocking mode that is selected depending on the needs to suit each purpose.

### Thirtieth Embodiment

The loop attack statistics are processed in the following manner depending on the contents of the frame.

30-1) The process of monitoring and detecting the loop in the first embodiment is carried out with respect to the MAC frames (frames not including layer 3 or greater).

30-2) The process of monitoring and detecting the loop in the first embodiment is carried out with respect to the IPv4 TCP frames. The statistics for each attacked TCP/UDP destination port number are processed as in the ninth embodiment. The statistics for each TCP/UDP destination port number per attacking IPSA are processed as in the tenth embodiment. The statistics of the IP destination numbers per attacking IPSA are processed as in the eleventh embodiment.

30-3) The process of monitoring and detecting the loop in the first embodiment is carried out with respect to the IPv4 UDP frames. The statistics for each attacked TCP/UDP destination port number are processed as in the ninth embodiment. The statistics for each TCP/UDP destination port number per attacking IPSA are processed as in the tenth embodiment. The statistics of the IP destination numbers per attacking IPSA are processed as in the eleventh embodiment.

30-4) The process of monitoring and detecting the loop in the first embodiment is carried out with respect to the IPv4 ARP frames. The statistics for the ARP frame number per attacking IPSA are processed as in the twelfth embodiment.

30-5) The process of monitoring and detecting the loop in the first embodiment is carried out with respect to the IPv4 ICMP frames. The statistics for the ICMP frame number per attacking IPSA are processed as in the thirteenth embodiment.

According to this embodiment, the process of monitoring and detecting of the loop and the process of monitoring and detecting of the attack can be carried out in parallel. Hence, it is possible to eliminate the abnormal traffic by one abnormal traffic eliminating apparatus with respect to the simultaneously generated loop and attack.

### Thirty-First Embodiment

The purging of the monitoring tables is carried out by the following process. Each monitoring table can be purged independently.

31-1) With respect to the FCS monitoring table, the network instantaneously (for example, in several seconds) assumes a non-communicatable state when a loop is once generated in the network. It requires considerable time to restore the network back to the original state. Since the FCS is added to all of the frames, there is a high possibility that the entry of the FCS monitoring table (portion where the entry is written) becomes full within a short time. Hence, the following steps are carried out.

31-1a) A purge command is issued with respect to the FCS monitoring table (for example, 16 Kwords) for every predetermined period (for example, 1 second).

31-1b) The FCS values in the entries are all invalidated when the purge command is received.

31-1c) When the purging is completed, entries of the FCS values are newly made from an address 0 of the FCS monitoring table, so that the loop can always be monitored using the newest information. If an entry exceeding the threshold value of the loop frame count is detected between 2 purges, the FCS monitoring table is held (that is, the purging is aborted), and the loop frame is blocked. When the loop frame converges, the periodic purging is restarted. If there is no entry exceeding the threshold value of the loop frame count, the steps 31-1a) through 31-1c) are repeated.

31-2) With respect to the TCP/UDP destination port number monitoring table, the TCP/UDP destination port number monitoring table per IPSA, and the destination (IPDA) number monitoring table per IPSA, it may be regarded that the possibility of the network assuming the non-communicatable state due to the IPv4 TCP/UDP attack is low compared to that caused by the loop. When the attack is generated, the processing performance of the relay apparatus such as the router deteriorates, and a congestion is generated in the network. Hence, the following steps are carried out.

31-2a) A purge command is issued with respect to the TCP/UDP destination port number monitoring table (for example, 16 Kwords), the TCP/UDP destination port number monitoring table per IPSA (for example, 32 Kwords), and the destination (IPDA) number monitoring table per IPSA (for example, 32 Kwords) for every predetermined period (for example, 30 seconds).

31-2b) The TCP/UDP destination port numbers, the Protocol, the IPDA and the IPSA in the entries are all invalidated when the purge command is received.

31-2c) When the purging is completed, entries of the TCP/UDP destination port numbers, the Protocol, the IPDA and the IPSA are newly made from an address 0 of the TCP/UDP destination port number monitoring table, the TCP/UDP destination port number monitoring table per IPSA, and the destination (IPDA) number monitoring table per IPSA, so that the IPv4 TCP/UDP attack can always be monitored using the newest information.

31-3) With respect to the ARP monitoring table per IPSA, it may be regarded that the possibility of the network assuming the non-communicatable state due to the IPv4 ARP attack is low compared to that caused by the loop. When the attack is generated, the processing performance of the relay apparatus such as the router deteriorates, and a congestion is generated in the network. Hence, the following steps are carried out.

31-3a) A purge command is issued with respect to the ARP monitoring table per IPSA (for example, 16 Kwords) for every predetermined period (for example, 30 seconds).

31-3b) The IPSA values in the entries are all invalidated when the purge command is received.

31-3c) When the purging is completed, entries of the IPSA values are newly made from an address 0 of the ARP monitoring table per IPSA, so that the IPv4 ARP attack can always be monitored using the newest information.

31-4) With respect to the ICMP monitoring table per IPSA, it may be regarded that the possibility of the network assuming the non-communicatable state due to the IPv4 ICMP attack is low compared to that caused by the loop. When the attack is generated, the processing performance of the relay apparatus such as the router deteriorates, and a congestion is generated in the network. Hence, the following steps are carried out.

31-4a) A purge command is issued with respect to the ICMP monitoring table per IPSA (for example, 16 Kwords) for every predetermined period (for example, 30 seconds).

31-4b) The IPSA values in the entries are all invalidated when the purge command is received.

31-4c) When the purging is completed, entries of the IPSA values are newly made from an address 0 of the ICMP monitoring table per IPSA, so that the IPv4 ICMP attack can always be monitored using the newest information.

According to this embodiment, it is possible to improve the monitoring accuracy by periodically purging and updating the entries of the FCS monitoring table, the TCP/UDP destination port number monitoring table, the TCP/UDP destination port number monitoring table per IPSA, the destination (IPDA) number monitoring table per IPSA, the ARP monitoring table per IPSA and the ICMP monitoring table per IPSA.

### Thirty-Second Embodiment

The processes of monitoring and blocking the attack can be carried out in parallel in the following manner.

32-1) IPv4 TCP/UDP frame

The TCP/UDP destination port number monitoring table, the TCP/UDP destination port number monitoring table per IPSA, and the destination (IPDA) number monitoring table per IPSA are purged at a predetermined period (for example, 30 seconds), and the monitoring is stopped during the purging. The monitoring or blocking of the IPv4 TCP/UDP frame is carried out between one purge and the next purge. The process of determining the blocking target of the attacking IPv4 frames of the seventeenth embodiment and the process of determining the pass rate of the attacking IPv4 frames of the eighteenth embodiment are carried out immediately before carrying out the purge operation. After the purge, the process of limiting the band of the attacking IPv4 frames of the nineteenth embodiment is carried out, so as to block the attacking IPv4 TCP/UDP frame.

32-2) IPv4 ARP Frame

The ARP monitoring table per IPSA is purged at a predetermined period (for example, 30 seconds), and the monitoring is stopped during the purging. The monitoring or blocking of the IPv4 ARP frame is carried out between one purge and the next purge. The process of determining the blocking target of the attacking ARP frames of the twentieth embodiment and the process of determining the pass rate of the attacking ARP frames of the twenty-first embodiment are carried out immediately before carrying out the purge operation. After the purge, the process of limiting the band of the attacking ARP frames of the twenty-second embodiment is carried out, so as to block the attacking IPv4 ARP frame.

32-3) IPv4 ICMP Frame

The ICMP monitoring table per IPSA is purged at a predetermined period (for example, 30 seconds), and the monitoring is stopped during the purging. The monitoring or blocking of the IPv4 ICMP frame is carried out between one purge and the next purge. The process of determining the blocking target of the attacking ICMP frames of the twenty-third embodiment and the process of determining the pass rate of the attacking ICMP frames of the twenty-fourth embodiment are carried out immediately before carrying out the purge operation. After the purge, the process of limiting the band of the attacking ICMP frames of the twenty-fifth embodiment is carried out, so as to block the attacking IPv4 ICMP frame.

According to this embodiment, it is possible to carry out a statistical process with respect to the attack by the IPv4 TCP/UDP frame, the attack by the IPv4 ARP frame and the attack by the IPv4 ICMP frame, and to block the attacking frame after purging each monitoring table, so as to cope with the monitoring of the changing network.

### Thirty-Third Embodiment

The processing of the loop or attacking (loop/attacking) physical port is carried out in one of the following selected modes.

33-1) Divided mode: When carrying out the monitoring, detecting, statistical and blocking operations with respect to the loop/attacking frames received by the plurality of ports of the abnormal traffic eliminating apparatus, the operations are carried out for each physical port number of the ports.

33-2) Shared mode: When carrying out the monitoring, detecting, statistical and blocking operations with respect to the loop/attacking frames received by the plurality of ports of the abnormal traffic eliminating apparatus, the operations are carried out without separating the process for each physical port number of the ports.

According to this embodiment, the divided mode (aware of the port) or the shared mode (not aware of the port) can be selected, so that it is possible to cope with the bi-directional traffic monitoring process and the one-directional traffic monitoring process with respect to the network.

[First Modification]

Next, a description will be given of a first modification which carries out the monitoring, detecting, statistical and blocking operations with respect to the loop. This first modification employs the monitoring and detecting of the loop according to the first embodiment, the blocking of the loop frame according to the second embodiment, the selection of the loop frame blocking mode according to the third embodiment, the selection of the loop frame blocking target according to the fourth embodiment, the blocking of the loop frame according to the fifth embodiment, the limiting of the band of the loop frame according to the sixth embodiment, the display of the statistical information of the loop frame according to the seventh embodiment, the processing of the loop attack statistics according to the thirtieth embodiment, the purging of the monitoring table according to the thirty-first embodiment, and the processing of the loop/attacking physical port in the selected mode according to the thirty-third embodiment.

Loop Frame Monitoring

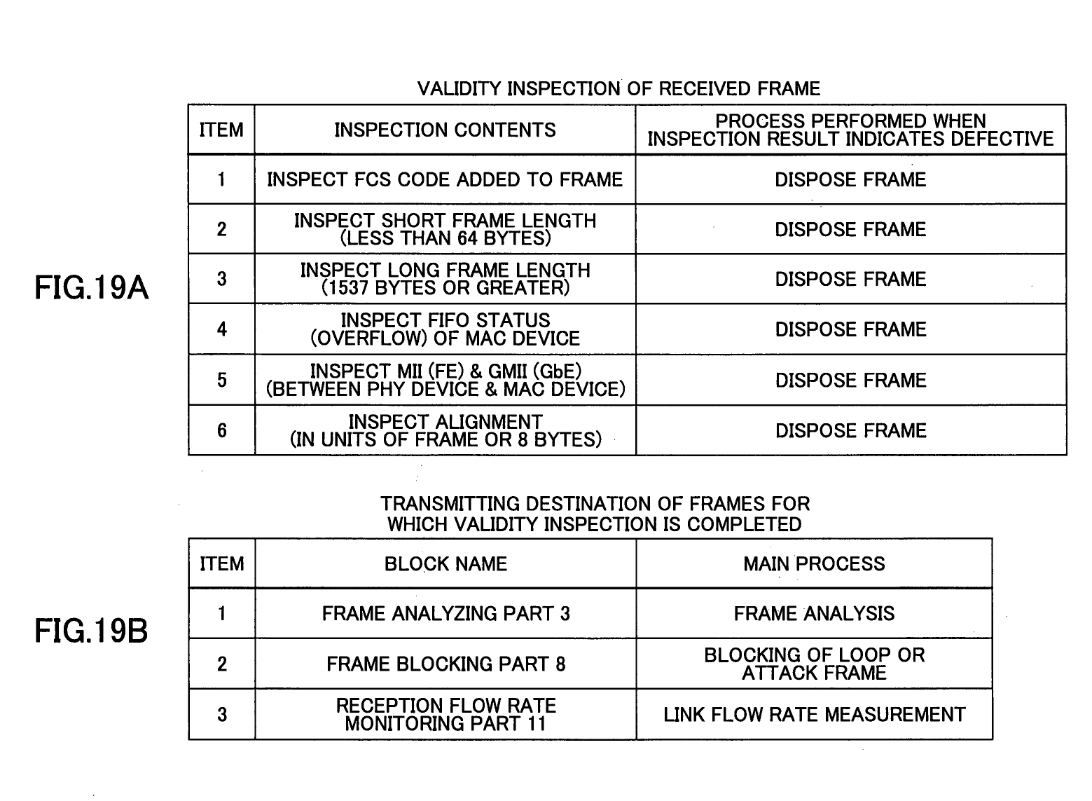

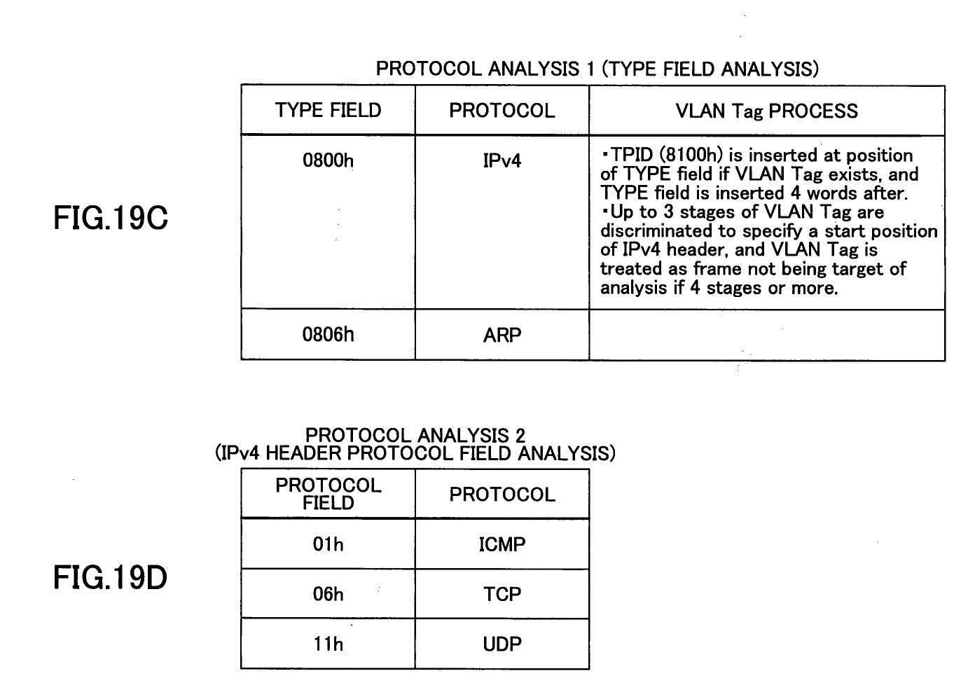

(1) Process of receiving frame from network: An Ethernet (registered trademark) frame received from the network is first input to the Port0 reception circuit I/F part 1 and the Port1 reception circuit I/F part 2 shown in FIG. 1 wherein the validity of the received frame is inspected. Inspection contents are shown in FIG. 19A. FIGS. 19A through 19D are diagrams for explaining the validity inspection of the received frame and the like. After the validity inspection is completed, the received frame is sent to the frame analyzing part 3, the frame blocking part 8 and the reception flow rate monitoring part 11 shown in FIG. 1. Main functions of the frame analyzing part 3, the frame blocking part 8 and the reception flow rate monitoring part 11 are shown in FIG. 19B.

(2) Frame Analyzing Process:

The frame analyzing part 3 analyzes the contents of the frame in the following manner.

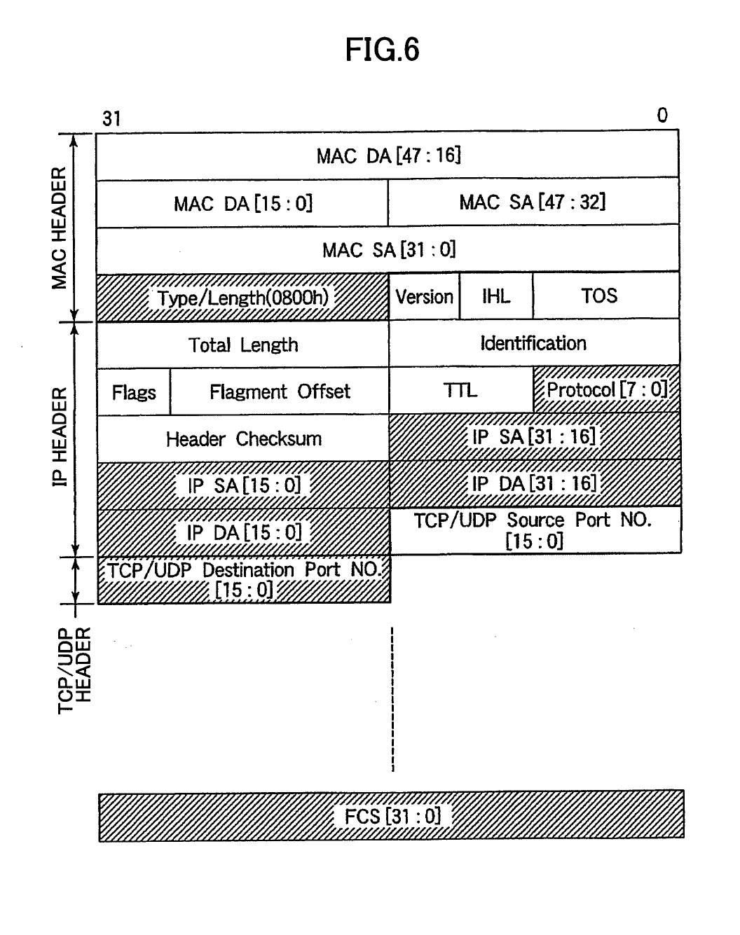

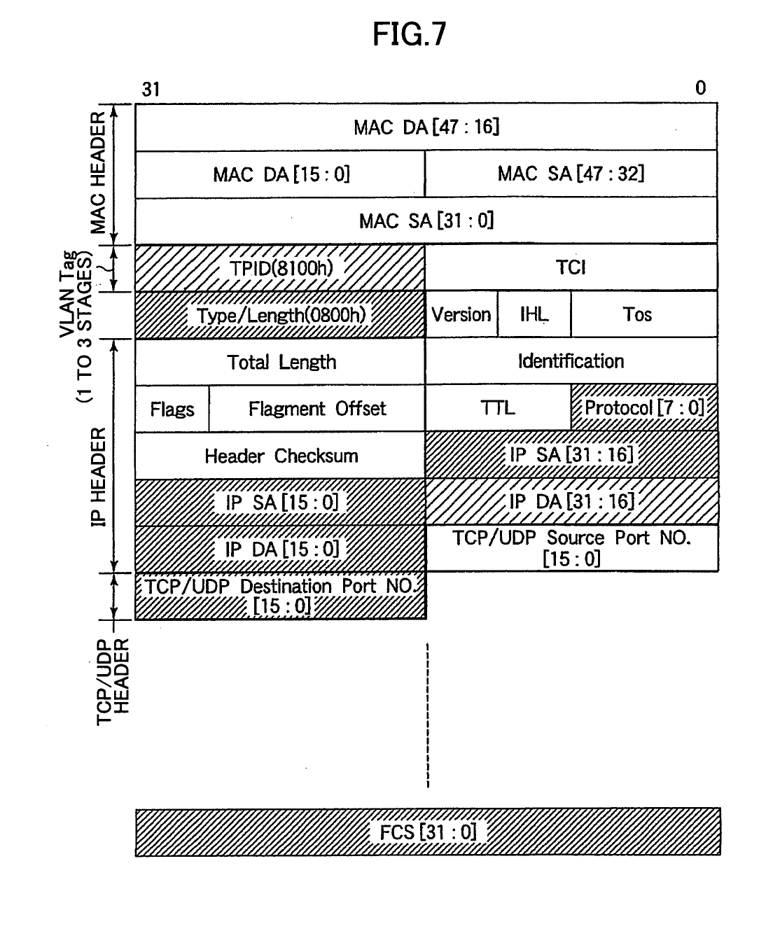

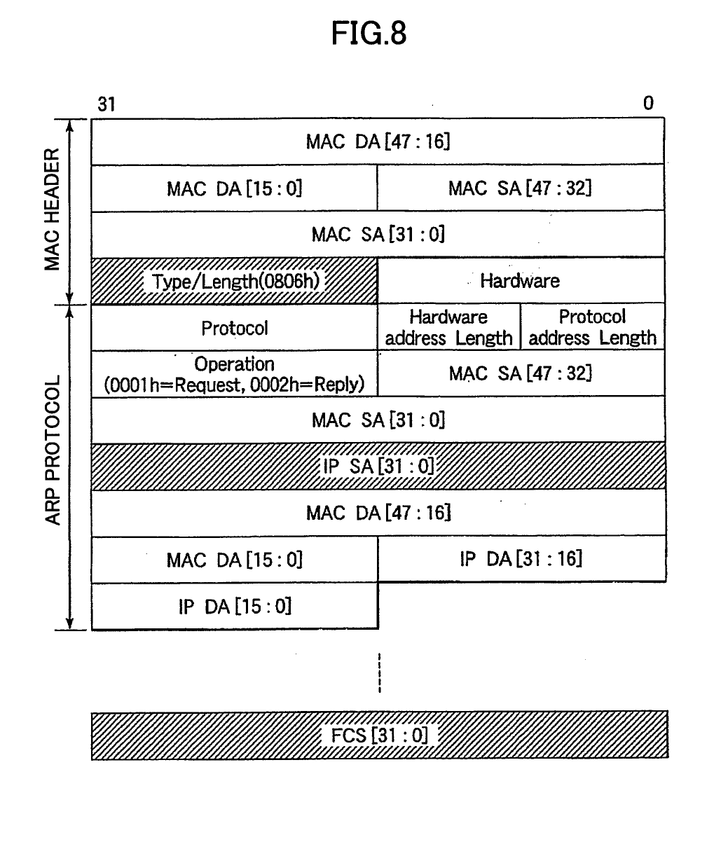

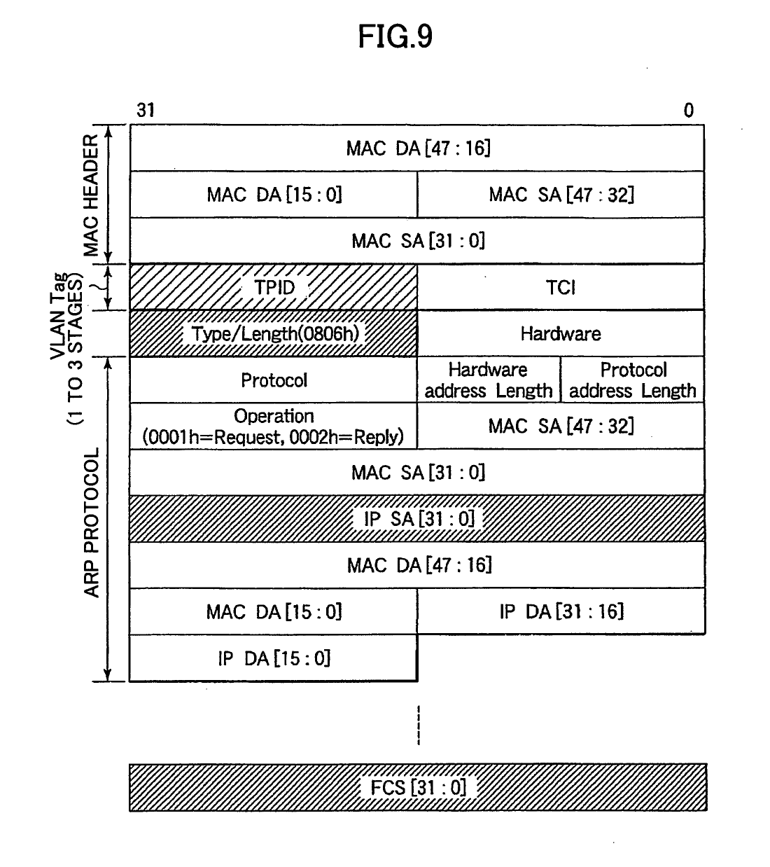

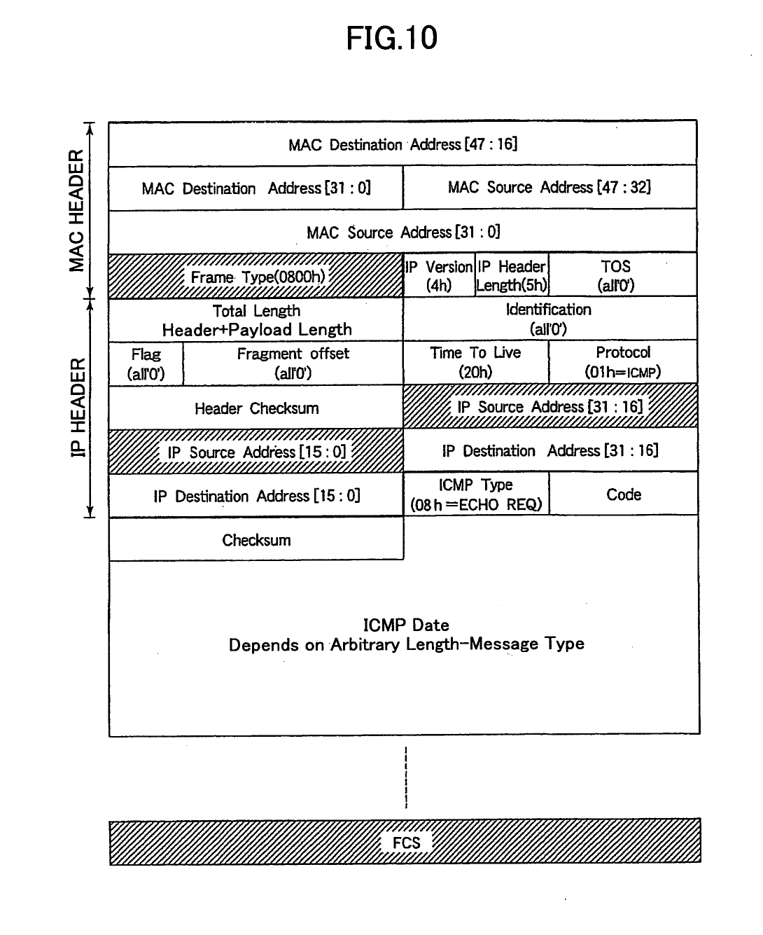

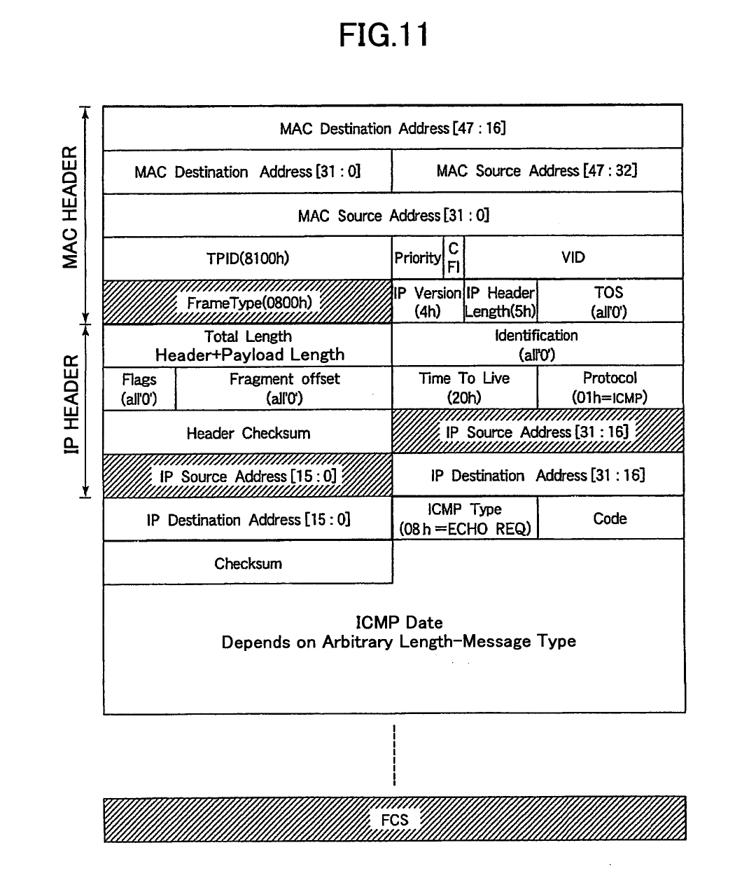

a) Protocol analysis 1 (TYPE field analysis): The protocol is discriminated from the TYPE field of the Ethernet frame, as shown in FIG. 19C. The IPv4 frame format is shown in FIGS. 6 and 7, and the ARP frame format is shown in FIGS. 8 and 9. In addition, the ICMP frame format is shown in FIGS. 10 and 11. FIG. 6 is a diagram showing the IPv4 frame format without VLAN_Tag, and FIG. 7 is a diagram showing the IPv4 frame format with VLAN_Tag. FIG. 8 is a diagram showing the ARP frame format without VLAN_Tag, and FIG. 9 is a diagram showing the ARP frame format with VLAN_Tag. FIG. 10 is a diagram showing the ICMP frame format without VLAN_Tag, and FIG. 11 is a diagram showing the ICMP frame format with VLAN_Tag. In FIGS. 6 through 11, a portion with the hatching indicates a search keyword for monitoring the loop or attack.

b) Protocol analysis 2 (IPv4 header protocol field analysis): The higher layer protocol is discriminated from the Protocol field of the IPv4 header, as shown in FIG. 19D.

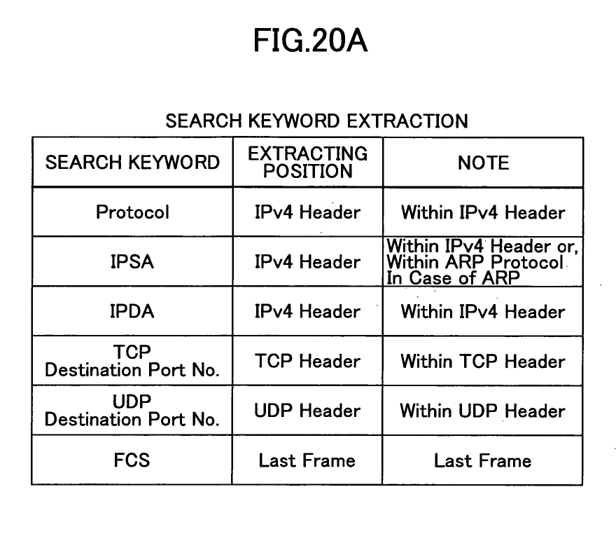

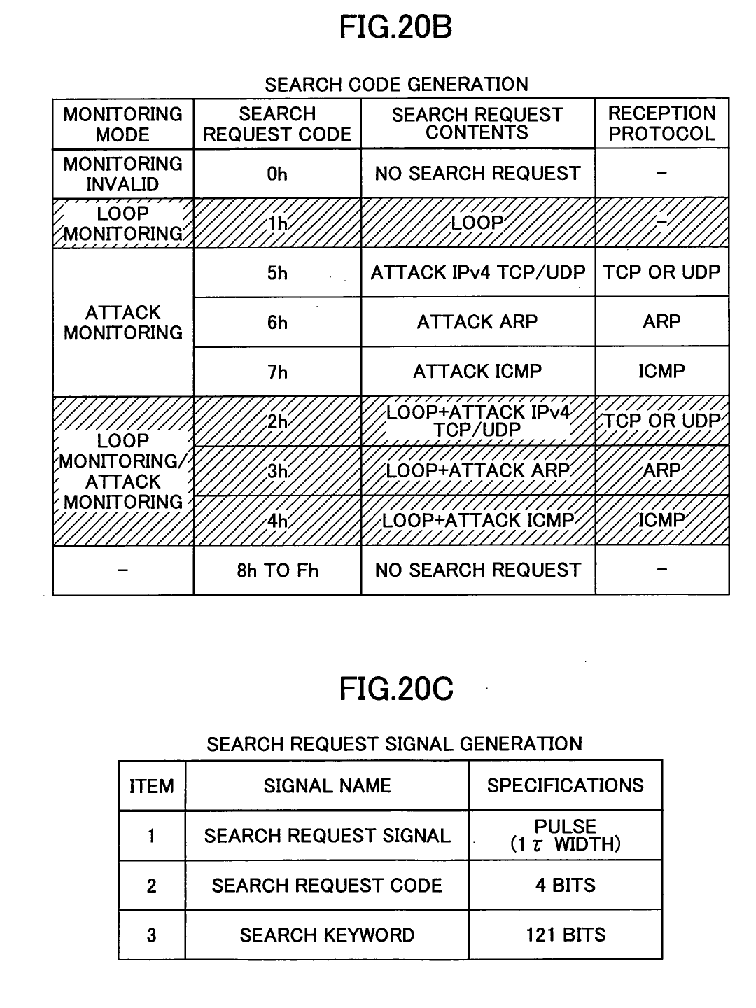

c) Extraction of search keyword: The search keyword is extracted based on the analysis results of the TYPE field and the IPv4 protocol field, as shown in FIG. 20A. FIGS. 20A through 20C are diagrams for explaining the search keyword extraction and the like.

d) Generation of search code: A search request code to be sent to the loop monitoring part 4 and the attack monitoring part 5 is generated from loop and attack monitoring enable signals, as shown in FIG. 20B. The search code for the loop monitoring is indicated by hatching in FIG. 20B.

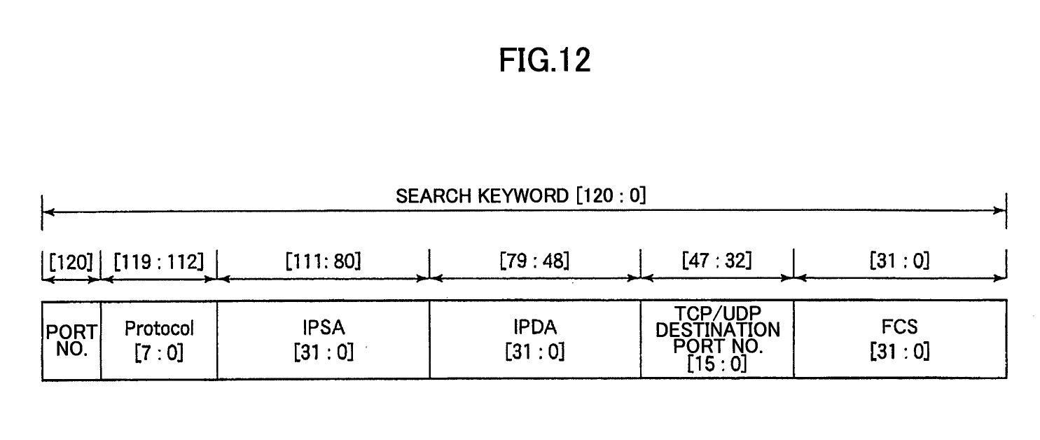

e) Connecting search keyword: Each search keyword is connected to 121 bits. FIG. 12 is a diagram showing a search keyword structure. When carrying out the loop monitoring, the FCS is the search keyword.

f) Generation of search request signal: Signals shown in FIG. 20C are sent to the loop monitoring part 4 and the attack monitoring part 5.

(3) Loop Monitoring:

Based on the search request from the frame analyzing part 3, the loop monitoring part 4 carries out a search (or lookup) with respect to the search engine. When a search result is returned from the search engine, the following process is carried out depending on the search result.

a) When the search mishits (search fails): The FCS value is written in the FCS monitoring table, and an entry is newly created. The FCS frame counter which is allocated for each entry within the FCS frame count table is set to “1” (only the first time).

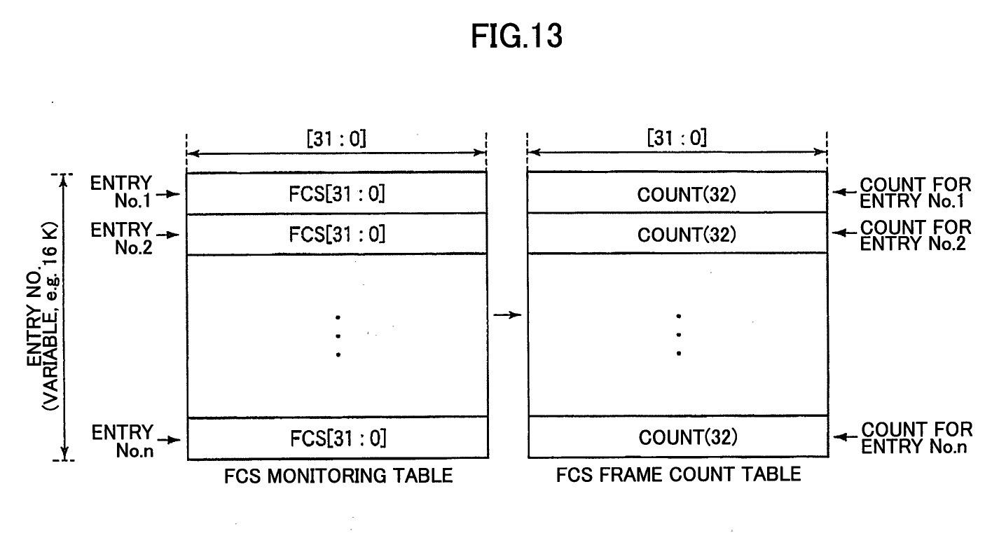

b) When the search hits (search is successful): The FCS frame counter allocated for each entry within the FCS frame count table is incremented (“1” is added to previous value for the second and subsequent times). FIG. 13 is a diagram showing structures of the loop monitoring table and the FCS frame count table.

Detection of Loop Frame:

Loop state detection: If the value of the FCS frame counter that is monitored when the search hits exceeds the preset threshold value of the frame count, the loop detecting part 6 judges that the network has assumed a loop state and asserts an alarm, and simultaneously notifies the FCS value to the frame analyzing part 3.

When the search hits (search is successful): The loop detecting part 6 carries out the following process. The loop detecting part 6 makes a search request with respect to the search engine, and receives a search hit signal when the search is successful. The loop detecting part 6 reads the FCS frame count table corresponding to the entry number of the monitoring table, and compares the read value from the FCS frame count table with the preset threshold value of the frame count. The loop detecting part 6 increments the read value by “1” and stores incremented read value in the FCS frame count table. If the read value is larger as a result of the comparison with the threshold value, the loop detecting part 6 detects the loop state of the network and generates the alarm (interrupt) with respect to the control part 13 (interrupt notification). The loop detecting part 6 notifies the FCS value of the frame for which the alarm was generated, to the frame analyzing part 3. When the alarm (interrupt) is detected in the control part 13, the generation of the loop state is displayed on the control screen of the abnormal traffic eliminating apparatus, so as to notify the operator of the loop state.

Statistics of Loop Frame:

The following 3 items are displayed as statistical information of the loop frame.

Item 1: The number of entries of the loop frame (the number of entries for which the frame count exceeds the threshold value is accumulated in the counter that is formed by a register within the loop detecting part 6, and the number of entries of the loop frame is displayed on the control screen of the abnormal traffic eliminating apparatus to notify the same to the operator).

Item 2: The number of loop frames per entry (the frame count per entry for which the frame count exceeds the threshold value is accumulated in the FCS frame count table within the loop monitoring part 4, and the number of loop frames is displayed on the control screen of the abnormal traffic eliminating apparatus to notify the same to the operator).

Item 3: The total number of loop frames (the total of the frame counts per entry for which the frame count exceeds the threshold value is accumulated in the counter that is formed by the register within the loop detecting part 6, and the total number of loop frames is displayed on the control screen of the abnormal traffic eliminating apparatus to notify the same to the operator).

Blocking of Loop Frame:

(1) Identifying loop frame: The frame analyzing part 3 identifies the loop frame by the following process. The frame analyzing part 3 receives an alert generation signal and the FCS value from the loop detecting part 6. The FCS value is held within the frame analyzing part 3, and is compared with the FCS value of the received frame so as to perform a filtering. The frame analyzing part 3 adds the flag with respect to the frame matching the filtering, and sends the frame that is added with the flag to the frame blocking part 8.

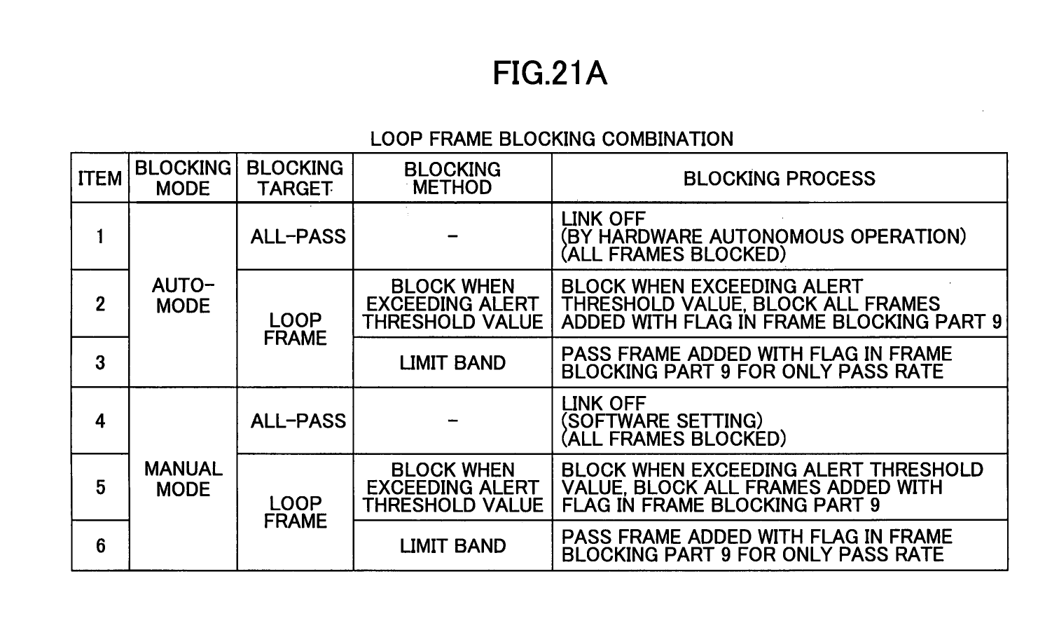

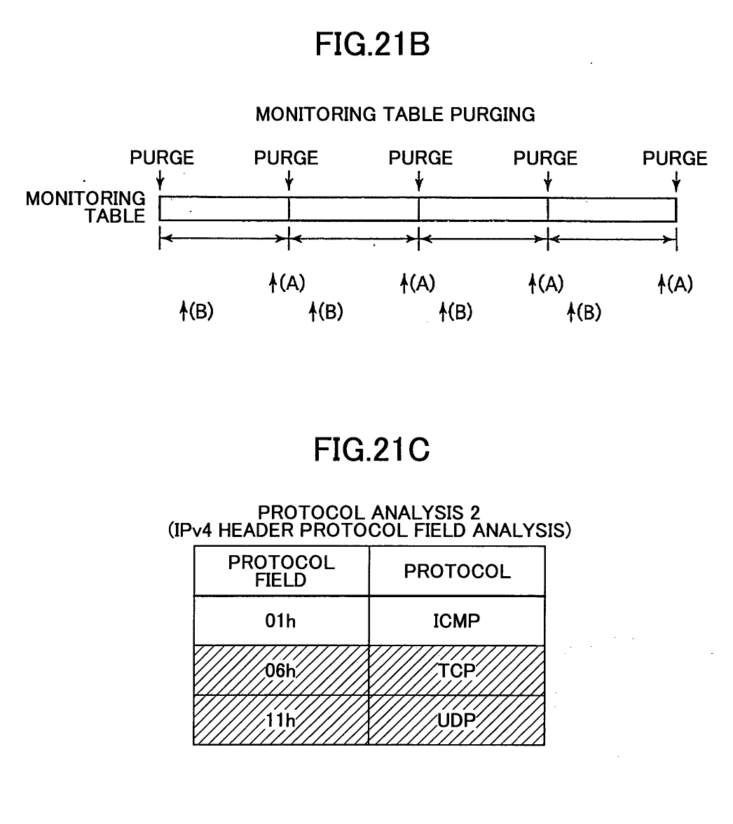

(2) Loop frame blocking combination: The blocking of the loop frame is carried out by the combination shown in FIG. 21A. FIGS. 21A through 21C are diagrams for explaining the loop frame blocking combination and the like.

(3) Loop frame blocking method: A store-and-forward frame buffer is provided within the frame blocking part 8, and the registration and disposal of the frame is determined when completing the storage of the frame. If the loop frame is added with the flag, the blocking of the loop frame is realized by not registering the frame but disposing the frame.

(4) Loop frame pass rate: The pass rate is calculated from the band that is entered by the operator from the control screen of the abnormal traffic eliminating apparatus. In the case of the loop frame that is added with the flag, the number of bytes that are actually transmitted is added in units of frames, and the number of transmitting bytes within 100 ms is suppressed by stopping the transmission from the point in time when the number of bytes transmitted in 100 ms exceeds the threshold value (pass rate). Although an excess number of bytes will be generated, the excess number of bytes can be added as the number of bytes in the next 100 ms, so as to limit the band in terms of the average value.

Purging FCS Monitoring Table:

Periodic purging: In order to constantly monitor the newest network, the FCS monitoring table is periodically purged by the following process. As shown in FIG. 21B, a purge command is periodically (for example, every 1 second) issued with respect to the FCS monitoring table (for example, 16 Kwords). The loop monitoring part 4 purges the FCS monitoring table in response to the purge command. The entries of the FCS monitoring table are all invalidated when the purge command is issued. When the purging is completed, entries of the FCS values are newly made from an address 0 of the FCS monitoring table, and the frame count within the FCS frame count table is started from “1”. If an entry exceeding the threshold value of the loop frame count is detected between one purge and the next purge, the FCS monitoring table is held (that is, purging is aborted), and the loop frame is blocked. When the loop frame converges, the periodic purging is restarted.

[Second Modification]

Next, a description will be given of a second modification which carries out the monitoring, detecting, statistical and blocking operations with respect to the attacking IPv4 TCP/UDP frame. This second modification employs the monitoring and detecting of the attack according to the eighth embodiment, the processing of the statistics for each attacked TCP/UDP destination port number according to the ninth embodiment, the processing of the statistics for each attacked TCP/UDP destination port number per IPSA according to the tenth embodiment, the processing of the statistics for the IP destination number per attacking IPSA according to the eleventh embodiment, the processing of the statistics for the attacking IPv4 frames according to the fourteenth embodiment, the determining of the blocking target of the attacking IPv4 frames according to the seventeenth embodiment, the determining of the pass rate of the attacking IPv4 frames according to the eighteenth embodiment, the limiting of the band of the attacking IPv4 frames according to the nineteenth embodiment, the displaying the attack cause of the attacking IPv4 frames according to the twenty-sixth embodiment, the processing of the attacking frame in the automatic blocking mode according to the twenty-ninth embodiment, the processing of the loop attack statistics according to the thirtieth embodiment, the purging of the monitoring table according to the thirty-first embodiment, the parallel processing of the monitoring and blocking according to the thirty-second embodiment, and the processing of the loop/attacking physical port in the selected mode according to the thirty-third embodiment.

Monitoring Attacking IPv4 TCP/UDP Frame:

(1) Process of receiving frame from network:

The Ethernet (registered trademark) frame received from the network is first input to the Port0 reception circuit I/F part 1 and the Port1 reception circuit I/F part 2 shown in FIG. 1 wherein the validity of the received frame is inspected. The inspection contents are shown in FIG. 19A. After the validity inspection is completed, the received frame is sent to the frame analyzing part 3, the frame blocking part 8 and the reception flow rate monitoring part 11 shown in FIG. 1. The main functions of the frame analyzing part 3, the frame blocking part 8 and the reception flow rate monitoring part 11 are shown in FIG. 19B.

(2) Frame Analyzing Process:

The frame analyzing part 3 analyzes the contents of the frame in the following manner.

a) Protocol analysis 1 (TYPE field analysis): The protocol is discriminated from the TYPE field of the Ethernet frame, as shown in FIG. 19C. The IPv4 frame format is shown in FIGS. 6 and 7.

b) Protocol analysis 2 (IPv4 header protocol field analysis): The higher layer protocol TCP/UDP indicated by hatching in FIG. 21C is discriminated from the Protocol field of the IPv4 header.

c) Extraction of search keyword: The search keyword is extracted based on the analysis results of the TYPE field and the IPv4 protocol field, as shown in FIG. 20A.

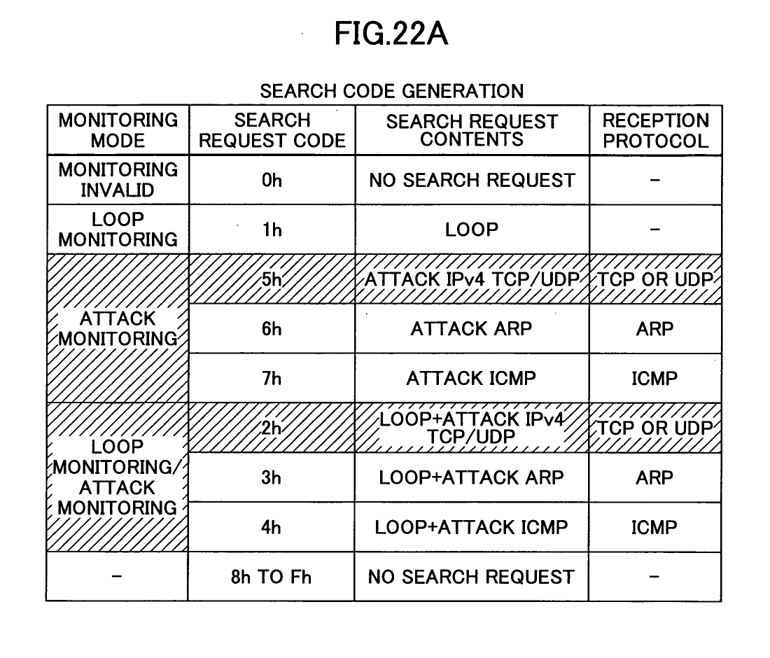

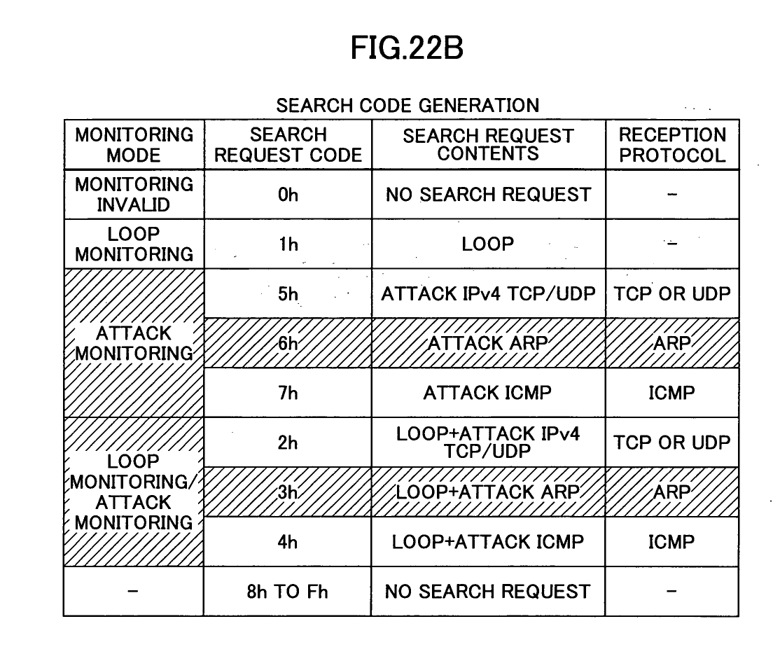

d) Generation of search code: A search request code to be sent to the loop monitoring part 4 and the attack monitoring part 5 is generated from the loop and attack monitoring enable signals. The monitoring of the attacking IPv4 TCP/UDP frames is indicated by hatching in FIG. 22A. FIGS. 22A and 22B are diagrams for explaining the search code generation and the like.

e) Connecting search keyword: Each search keyword is connected to 121 bits. FIG. 12 shows the search keyword structure. For the monitoring of the attacking IPv4 TCP/UDP frames, all of the fields are search keywords.

f) Generation of search request signal: The signals shown in FIG. 20C are sent to the loop monitoring part 4 and the attack monitoring part 5.

(3) Monitoring Attacking IPv4 TCP/UDP Frames:

The monitoring of the attacking IPv4 TCP/UDP frames include the following 4 items.

Item 1: Link band monitoring (the number of received frames, the number of received bytes and the number of erroneous frames are measured for each of the connection terminals Port0 and Port1 in the reception flow rate monitoring part 11).

Item 2: Statistics for each TCP/UDP destination port number (the attack monitoring part 5 carries out a search (or lookup) with respect to the search engine based on the search request from the frame analyzing part 3, and the following process is carried out depending on the search result since the search result is returned from the search engine).

a) When the search mishits (search fails): The value of the TCP/UDP destination port number is written in the TCP/UDP destination port number monitoring table, and an entry is newly created. The TCP/UDP destination port number frame counter which is allocated for each entry within the TCP/UDP destination port number frame count table is set to “1” (only the first time).

b) When the search hits (search is successful): The TCP/UDP destination port number frame counter allocated for each entry within the TCP/UDP destination port number frame count table is incremented (“1” is added to previous value for the second and subsequent times).

Item 3: Statistics for each TCP/UDP destination port number per IPSA (the attack monitoring part 5 carries out a search (or lookup) with respect to the search engine based on the search request from the frame analyzing part 3, and the following process is carried out depending on the search result since the search result is returned from the search engine).

a) When the search mishits (search fails): The values of the TCP/UDP destination port number, the Protocol field and the IPSA are written in the TCP/UDP destination port number monitoring table per IPSA, and an entry is newly created. The TCP/UDP destination port number frame counter per IPSA, which is allocated for each entry within the TCP/UDP destination port number frame count table per IPSA, is set to “1” (only the first time).

b) When the search hits (search is successful): The TCP/UDP destination port number frame counter per IPSA, allocated for each entry within the TCP/UDP destination port number frame count table per IPSA, is incremented (“1” is added to previous value for the second and subsequent times).

Item 4: Statistics for the IP destination number per IPSA (the attack monitoring part 5 carries out a search (or lookup) with respect to the search engine based on the search request from the frame analyzing part 3, and the following process is carried out depending on the search result since the search result is returned from the search engine).

a) When the search mishits (search fails): The values of the IPDA and IPSA are written in the IP destination number monitoring table per IPSA, and an entry is newly created. The IP destination number frame counter per IPSA, which is allocated for each entry within the IP destination number frame count table per IPSA, is set to “1” (only the first time).

b) When the search hits (search is successful): The IP destination number frame counter per IPSA, allocated for each entry within the IP destination number frame count table per IPSA, is incremented (“1” is added to previous value for the second and subsequent times).

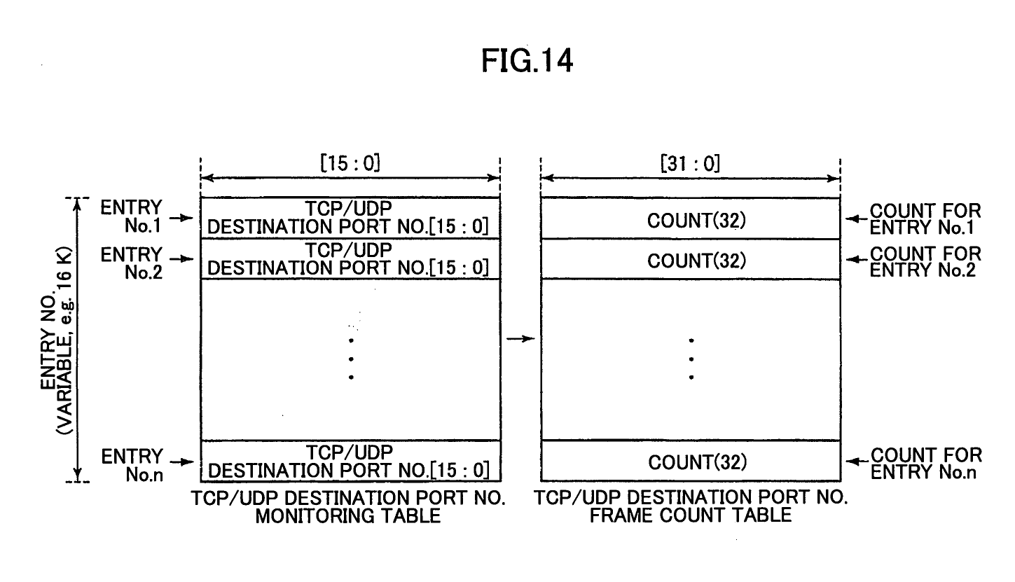

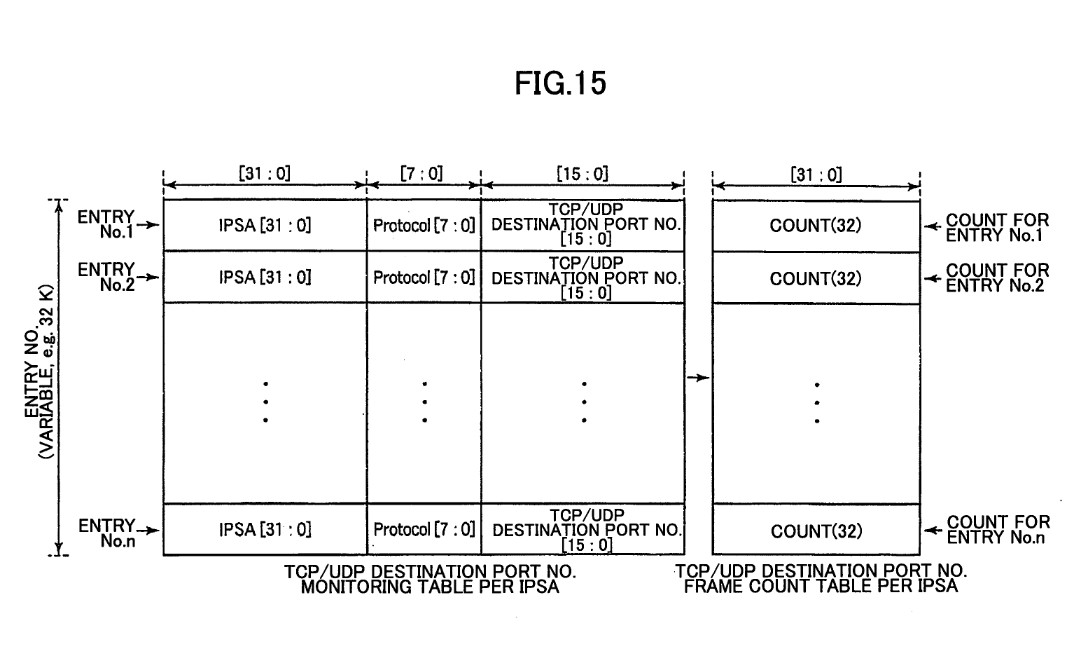

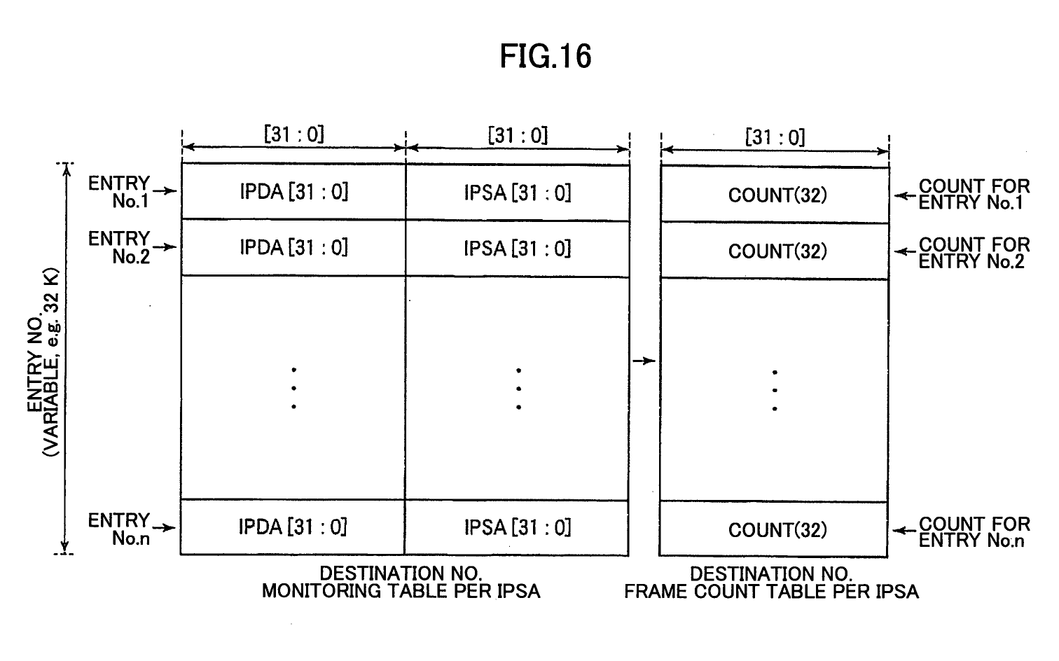

FIG. 14 is a diagram showing a structure of the attack TCP/UDP destination port number monitoring table, FIG. 15 is a diagram showing a structure of the TCP/UDP destination port-number monitoring table per attack IPSA, and FIG. 16 is a diagram showing a structure of the IP destination number monitoring table per attack IPSA.

Detection of Attacking IPv4 TCP/UDP Frame:

Next, a description will be given of the detection techniques employed by the Items 1 through 4 described above under “(3) Monitoring attacking IPv4 TCP/UDP frames”.

Item 1: With respect to link band exceeding detection, the value to be measured is monitored by the reception flow rate monitoring part 11, and it is judged that an attack has been made if the flow rate of the frame exceeds the monitoring threshold value.

Item 2: For detecting statistics of each TCP/UDP destination port number:

When the search hits (search is successful): The value of the TCP/UDP destination port number frame count corresponding to the entry number within the TCP/UDP destination port number frame count table is read, and compared with the preset threshold value of the frame count. The read frame count number is incremented by “1” and stored in the TCP/UDP destination port number frame count table. If the read frame count number is greater as a result of the comparison, an attacked state is detected, and an alert (interrupt) is notified to the control part 13 (that is, a failure notification is made). When the control part 13 detects the interrupt, the generation of the attacked state is displayed on the control screen of the abnormal traffic eliminating apparatus, so as to notify the operator of the attacked state.

Item 3: For detecting statistics of each TCP/UDP destination port number per IPSA:

When the search hits (search is successful): The value of the TCP/UDP destination port number frame count per IPSA corresponding to the entry number within the TCP/UDP destination port number frame count table per IPSA is read, and compared with the preset threshold value of the frame count. The read frame count number is incremented by “1” and stored in the TCP/UDP destination port number frame count table per IPSA. If the read frame count number is greater as a result of the comparison, an attacked state is detected, and an alert (interrupt) is notified to the control part 13 (that is, a failure notification is made). When the control part 13 detects the interrupt, the generation of the attacked state is displayed on the control screen of the abnormal traffic eliminating apparatus, so as to notify the operator of the attacked state.

Item 4: For detecting statistics of the IP destination number per IPSA:

When the search hits (search is successful): The value of the IP destination number frame count per IPSA corresponding to the entry number within the IP destination number frame count table per IPSA is read, and compared with the preset threshold value of the frame count. The read frame count number is incremented by “1” and stored in the IP destination number frame count table per IPSA. If the read frame count number is greater as a result of the comparison, an attacked state is detected, and an alert (interrupt) is notified to the control part 13 (that is, a failure notification is made). When the control part 13 detects the interrupt, the generation of the attacked state is displayed on the control screen of the abnormal traffic eliminating apparatus, so as to notify the operator of the attacked state.

With regard to the statistics of the attacking IPv4 TCP/UDP frames, the statistical information of the attacking IPv4 TCP/UDP frames is processed and displayed as follows.

Item 1: With respect to the TCP/UDP destination port numbers (top 10), if the IPv4 TCP/UDP statistic part within the attack statistic part 7 detects that the frame count number for each TCP/UDP destination port number monitored when the search hits exceeds the preset threshold value of the frame count, the top 10 TCP/UDP destination port numbers having the larger frame counts of those exceeding the preset threshold value are extracted from the TCP/UDP destination port number monitoring table within the attack monitoring part 5 and transferred to the register within the attack statistic part 7. These extracted top 10 TCP/UQP destination port numbers are displayed on the control screen of the abnormal traffic eliminating apparatus, so as to notify the same to the operator.

Item 2: With respect to the frame count number of the TCP/UDP destination port numbers (top 10), the frame count number for each of the extracted top 10 TCP/UDP destination port numbers is extracted from the TCP/UDP destination port number frame count table within the attack monitoring part 5, and the frame count is continued in the IPv4 TCP/UDP statistic part within the attack monitoring part 5. The frame count operation is carried out by use of the register within the attack statistic part 7. The extracted frame count numbers are displayed on the control screen of the abnormal traffic eliminating apparatus, so as to notify the same to the operator.

Item 3: With respect to the TCP/UDP destination port numbers (top 10) per IPSA, the value of the IPSA having the largest count for each of the extracted top 10 TCP/UDP destination port number is extracted from the TCP/UDP destination port number monitoring table per IPSA within the attack monitoring part 5 and transferred to the register within the attack statistic part 7. The extracted IPSA values are displayed on the control screen of the abnormal traffic eliminating apparatus, so as to notify the same to the operator.

Identifying Blocking Target of Attacking IPv4 TCP/UDP Frames:

The blocking target of the attacking IPv4 TCP/UDP frames is identified based on the statistical information, by carrying out the following process in a blocking target statistic part within the frame analyzing part 3.

a) Count the number of frames for each IPv4 TCP/UDP destination port number.

b) Count the number of bytes for each IPv4 TCP/UDP destination port number.

c) Calculate the band from the number of frames and the number of bytes counted.

The calculated band is displayed on the control screen of the abnormal traffic eliminating apparatus, so as to notify the same to the operator. The operator can hence recognize the band for each port number, and enter the band from the control screen with respect to the port number that is to be blocked.

Blocking of Attacking IPv4 TCP/UDP frames:

The attacking IPv4 TCP/UDP frame is blocked by the following process, based on the identification of the blocking target.

(1) Filtering attacking IPv4 TCP/UDP frames:

The frame analyzing part 3 identifies the attacking IPv4 TCP/UDP frame by carrying out the following process. When the operator enters the band for each port number that is to be blocked from the control screen, the frame analyzing part 3 holds the port number and compares this port number with the TCP/UDP destination port number of received frame. In addition, the frame analyzing part 3 adds the flag with respect to the frame which matches the filtering (that is, the frame having the port number matching that entered by the operator), and sends the frame that is added with the flag to the frame blocking part 8.

(2) Method of blocking attacking IPv4 TCP/UDP frames: A store-and-forward frame buffer is provided within the frame blocking part 8, and the registration and disposal of the frame is determined when completing the storage of the frame. If the attacking IPv4 TCP/UDP frame is added with the flag, the blocking of the attacking IPv4 TCP/UDP frame is realized by not registering the frame but disposing the frame.

(3) Pass rate for each TCP/UDP port number that is blocking target: The pass rate is calculated from the band that is entered by the operator from the control screen of the abnormal traffic eliminating apparatus. In the case of the attacking TCP/UDP frame that is added with the flag, the number of bytes that are actually transmitted is added in units of frames, and the number of transmitting bytes within 100 ms is suppressed by stopping the transmission from the point in time when the number of bytes transmitted in 100 ms exceeds the threshold value (pass rate). Although an excess number of bytes will be generated, the excess number of bytes can be added as the number of bytes in the next 100 ms, so as to limit the band in terms of the average value.

Purging Monitoring Tables, Purging Period, Monitoring Period and Blocking Period:

Periodic purging: In order to constantly monitor the newest network, each of the TCP/UDP destination port number monitoring table, the TCP/UDP destination port number monitoring table per IPSA, and the IP destination number monitoring table per IPSA is periodically purged by the following process. A purge command is periodically (for example, every 30 seconds) issued with respect to each of the TCP/UDP destination port number monitoring table, the TCP/UDP destination port number monitoring table per IPSA, and the IP destination number monitoring table per IPSA (for example, each of 16 Kwords). The attack monitoring part 5 purges each of the TCP/UDP destination port number monitoring table, the TCP/UDP destination port number monitoring table per IPSA, and the IP destination number monitoring table per IPSA in response to the corresponding purge command. The entries of the corresponding monitoring table are all invalidated when the purge command is issued. When the purging is completed, entries are newly made from an address 0 of each of the TCP/UDP destination port number monitoring table, the TCP/UDP destination port number monitoring table per IPSA, and the IP destination number monitoring table per IPSA, and the frame count within each of the 3 frame count tables is started from “1”.

In FIG. 21B, the statistics and the identification of the blocking target are obtained based on the monitoring and statistical information at a time (A), and the blocking is made based on the band entered by the operator at a time (B). The monitoring and statistical processes are carried out between one purge and the next purge, and the blocking process is carried out during the next period.

[Third Modification]

Next, a description will be given of a third modification which carries out the monitoring, detecting, statistical and blocking operations with respect to the attacking IPv4 TCP/UDP frame. This third modification employs the monitoring and detecting of the attack according to the eighth embodiment, the processing of the statistics for the attacking ARP frame per IPSA according to the twelfth embodiment, the processing of the statistics for the ARP frame according to the fifteenth embodiment, the determining of the blocking target of the attacking ARP frames according to the twentieth embodiment, the determining of the pass rate of the attacking ARP frames according to the twenty-first embodiment, the limiting of the band of the attacking ARP frames according to the twenty-second embodiment, the displaying the attack cause of the attacking ARP frames according to the twenty-seventh embodiment, the processing of the attacking frame in the automatic blocking mode according to the twenty-ninth embodiment, the processing of the loop attack statistics according to the thirtieth embodiment, the purging of the monitoring table according to the thirty-first embodiment, the parallel processing of the monitoring and blocking according to the thirty-second embodiment, and the processing of the loop/attacking physical port in the selected mode according to the thirty-third embodiment.

Monitoring Attacking IPv4 ARP Frame:

(1) Process of receiving frame from network:

The Ethernet (registered trademark) frame received from the network is first input to the Port0 reception circuit I/F part 1 and the Port1 reception circuit I/F part 2 shown in FIG. 1 wherein the validity of the received frame is inspected. The inspection contents are shown in FIG. 19A. After the validity inspection is completed, the received frame is sent to the frame analyzing part 3, the frame blocking part 8 and the reception flow rate monitoring part 11 shown in FIG. 1. The main functions of the frame analyzing part 3, the frame blocking part 8 and the reception flow rate monitoring part 11 are shown in FIG. 19B.

(2) Frame Analyzing Process:

The frame analyzing part 3 analyzes the contents of the frame in the following manner.

a) Protocol analysis 1 (TYPE field analysis): The protocol is discriminated from the TYPE field of the Ethernet frame, as shown in FIG. 19C. The ARP frame format is shown in FIGS. 8 and 9.

b) Protocol analysis 2 (IPv4 header protocol field analysis): The higher layer protocols ICMP, TCP and UDP are discriminated from the Protocol field of the IPv4 header, as shown in FIG. 19D.

c) Extraction of search keyword: The search keyword is extracted based on the analysis results of the TYPE field and the IPv4 protocol field, as shown in FIG. 20A.

d) Generation of search code: A search request code to be sent to the loop monitoring part 4 and the attack monitoring part 5 is generated from the loop and attack monitoring enable signals, as shown in FIG. 22B. The monitoring of the attacking IPv4 ARP frames is indicated by hatching in FIG. 22B.

e) Connecting search keyword: Each search keyword is connected to 121 bits. FIG. 12 shows the search keyword structure. For the monitoring of the attacking IPv4 ARP frames, the IPSA field is the search keyword.

f) Generation of search request signal: The signals shown in FIG. 20C are sent to the loop monitoring part 4 and the attack monitoring part 5.

(3) Monitoring attacking IPv4 ARP frames: The monitoring of the attacking IPv4 ARP frames include the following 2 items.

Item 1: Link band monitoring (the number of received frames, the number of received bytes and the number of erroneous frames are measured for each of the connection terminals Port0 and Port1 in the reception flow rate monitoring part 11).

Item 2: Statistics for the ARP per IPSA (the attack monitoring part 5 carries out a search (or lookup) with respect to the search engine based on the search request from the frame analyzing part 3, and the following process is carried out depending on the search result since the search result is returned from the search engine).

a) When the search mishits (search fails): The value of the IPSA is written in the ARP monitoring table per IPSA, and an entry is newly created. The ARP frame counter per IPSA, which is allocated for each entry within the ARP frame count table per IPSA, is set to “1” (only the first time).

b) When the search hits (search is successful):

The ARP frame counter per IPSA, allocated for each entry within the ARP frame count table per IPSA, is incremented (“1” is added to previous value for the second and subsequent times).

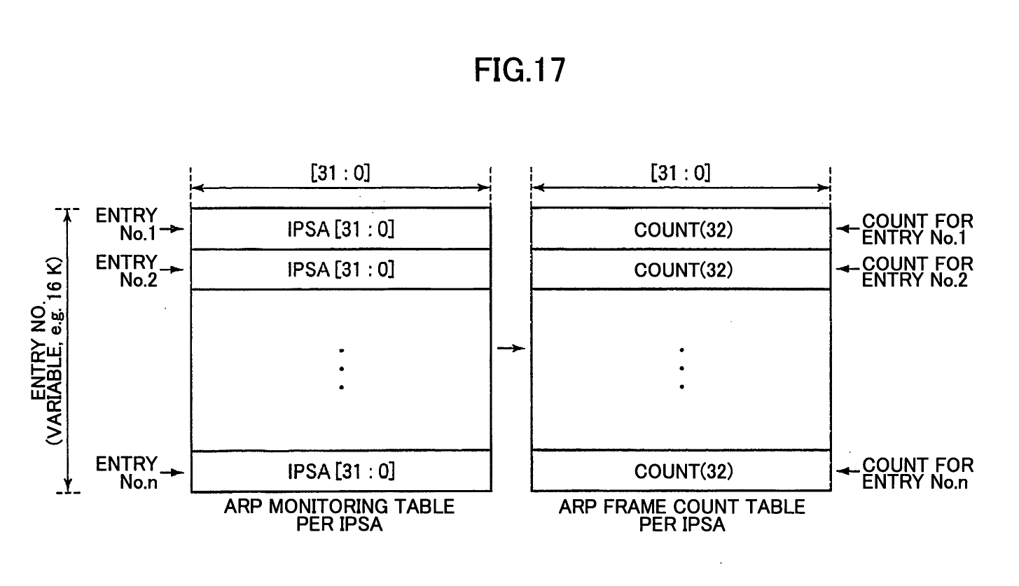

FIG. 17 is a diagram showing a structure of the ARP monitoring table per attack IPSA.

Detection of Attacking IPv4 ARP Frame:

Next, a description will be given of the detection techniques employed by the Items 1 and 2 described above under “(3) Monitoring attacking IPv4 ARP frames”.

Item 1: With respect to link band exceeding detection, the value to be measured is monitored by the reception flow rate monitoring part 11, and it is judged that an attack has been made if the flow rate of the frame exceeds the monitoring threshold value.

Item 2: For detecting statistics of ARP per IPSA:

When the search hits (search is successful): The value of the ARP frame count per IPSA corresponding to the entry number within the ARP frame count table per IPSA is read, and compared with the preset threshold value of the frame count. The read frame count number is incremented by “1” and stored in the ARP frame count table per IPSA. If the read frame count number is greater as a result of the comparison, an attacked state is detected, and an alert (interrupt) is notified to the control part 13 (that is, a failure notification is made). When the control part 13 detects the interrupt, the generation of the attacked state is displayed on the control screen of the abnormal traffic eliminating apparatus, so as to notify the operator of the attacked state.

With regard to the statistics of the attacking IPv4 ARP frames, the statistical information of the attacking IPv4 ARP frames is processed and displayed as follows.

Item 1: The ARP frame count number per IPSA is extracted from the ARP frame count table per IPSA within the attack monitoring part 5, and the frame count is continued in the ARP statistic part within the attack statistic part 7. The frame count operation is carried out using the register within the attack statistic part 7. The extracted ARP frame count number is displayed on the control screen of the abnormal traffic eliminating apparatus, so as to notify the same to the operator.

Item 2: The value of the IPSA having the largest count is extracted from the ARP monitoring table per IPSA within the attack monitoring part 5 and transferred to the register within the attack statistic part 7. The extracted IPSA value is displayed on the control screen of the abnormal traffic eliminating apparatus, so as to notify the same to the operator.

Identifying Blocking Target of Attacking IPv4 ARP Frames:

The blocking target of the attacking IPv4 ARP frames is identified based on the statistical information, by carrying out the following process in a blocking target statistic part within the frame analyzing part 3.

a) Count the number of ARP frames.

b) Count the number of ARP bytes.

c) Calculate the band from the number of frames and the number of bytes counted.

The calculated band is displayed on the control screen of the abnormal traffic eliminating apparatus, so as to notify the same to the operator. The operator can hence recognize the band of the ARP frame, and enter the band from the control screen with respect to the port number that is to be blocked.

Blocking of Attacking IPv4 ARP Frames:

The attacking IPv4 ARP frame is blocked by the following process, based on the identification of the blocking target.

(1) Filtering attacking IPv4 ARP frames: The frame analyzing part 3 identifies the attacking IPv4 ARP frame by carrying out the following process. When the operator enters the band that is to be blocked from the control screen, the frame analyzing part 3 identifies the ARP frame from the received frame. In addition, the frame analyzing part 3 adds the flag with respect to the frame which matches the filtering (that is, the frame having the band matching that entered by the operator), and sends the frame that is added with the flag to the frame blocking part 8.

(2) Method of blocking attacking IPv4 ARP frames: A store-and-forward frame buffer is provided within the frame blocking part 8, and the registration and disposal of the frame is determined when completing the storage of the frame. If the attacking IPv4 ARP frame is added with the flag, the blocking of the attacking IPv4 ARP frame is realized by not registering the frame but disposing the frame.

(3) Pass rate for ARP frame that is blocking target: The pass rate is calculated from the band that is entered by the operator from the control screen of the abnormal traffic eliminating apparatus. In the case of the attacking ARP frame that is added with the flag, the number of bytes that are actually transmitted is added in units of frames, and the number of transmitting bytes within 100 ms is suppressed by stopping the transmission from the point in time when the number of bytes transmitted in 100 ms exceeds the threshold value (pass rate). Although an excess number of bytes will be generated, the excess number of bytes can be added as the number of bytes in the next 100 ms, so as to limit the band in terms of the average value.

Purging ARP Monitoring Table Per IPSA, Purging Period, Monitoring Period and Blocking Period:

Periodic purging: In order to constantly monitor the newest network, the ARP monitoring table per IPSA is periodically purged by the following process. A purge command is periodically (for example, every 30 seconds) issued with respect to the ARP monitoring table per IPSA (for example, 32 Kwords). The attack monitoring part 5 purges the ARP monitoring table per IPSA in response to the purge command. The entries of the ARP monitoring table are all invalidated when the purge command is issued. When the purging is completed, entries are newly made from an address 0 of the ARP monitoring table per IPSA, and the frame count within the ARP frame count table per IPSA is started from “1”.

In FIG. 21B, the statistics and the identification of the blocking target are obtained based on the monitoring and statistical information at the time (A), and the blocking is made based on the band entered by the operator at the time (B). The monitoring and statistical processes are carried out between one purge and the next purge, and the blocking process is carried out during the next period.

[Fourth Modification]

Next, a description will be given of a fourth modification which carries out the monitoring, detecting, statistical and blocking operations with respect to the attacking IPv4 ICMP frame. This fourth modification employs the monitoring and detecting of the attack according to the eighth embodiment, the processing of the statistics for the attacking ICMP frame per IPSA according to the thirteenth embodiment, the processing of the statistics for the ICMP frame according to the sixteenth embodiment, the determining of the blocking target of the attacking ICMP frames according to the twenty-third embodiment, the determining of the pass rate of the attacking ICMP frames according to the twenty-fourth embodiment, the limiting of the band of the attacking ICMP frames according to the twenty-fifth embodiment, the displaying the attack cause of the attacking ICMP frames according to the twenty-eighth embodiment, the processing of the attacking frame in the automatic blocking mode according to the twenty-ninth embodiment, the processing of the loop attack statistics according to the thirtieth embodiment, the purging of the monitoring table according to the thirty-first embodiment, the parallel processing of the monitoring and blocking according to the thirty-second embodiment, and the processing of the loop/attacking physical port in the selected mode according to the thirty-third embodiment.

Monitoring Attacking IPv4 ARP Frame:

(1) Process of receiving frame from network:

The Ethernet (registered trademark) frame received from the network is first input to the Port0 reception circuit I/F part 1 and the Port1 reception circuit I/F part 2 shown in FIG. 1 wherein the validity of the received frame is inspected. The inspection contents are shown in FIG. 19A. After the validity inspection is completed, the received frame is sent to the frame analyzing part 3, the frame blocking part 8 and the reception flow rate monitoring part 11 shown in FIG. 1. The main functions of the frame analyzing part 3, the frame blocking part 8 and the reception flow rate monitoring part 11 are shown in FIG. 19B.

(2) Frame Analyzing Process:

The frame analyzing part 3 analyzes the contents of the frame in the following manner.

a) Protocol analysis 1 (TYPE field analysis): The protocol is discriminated from the TYPE field of the Ethernet frame, as shown in FIG. 19C. The ICMP frame format is shown in FIGS. 10 and 11.

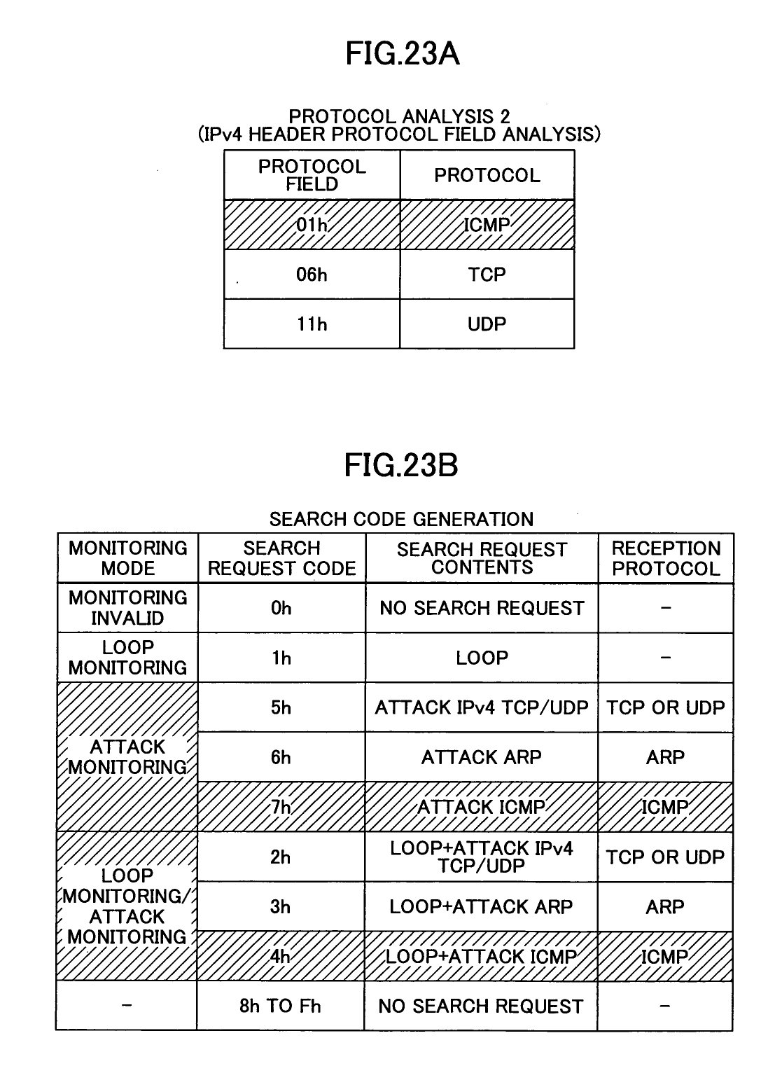

b) Protocol analysis 2 (IPv4 header protocol field analysis): The higher layer protocol ICMP is discriminated from the Protocol field of the IPv4 header, as shown in FIG. 23A. FIGS. 23A and 23B are diagrams for explaining the protocol analysis and the like.

c) Extraction of search keyword: The search keyword is extracted based on the analysis results of the TYPE field and the IPv4 protocol field, as shown in FIG. 20A.

d) Generation of search code: A search request code to be sent to the loop monitoring part 4 and the attack monitoring part 5 is generated from the loop and attack monitoring enable signals, as shown in FIG. 23B. The monitoring of the attacking IPv4 ICMP frames is indicated by hatching in FIG. 23B.

e) Connecting search keyword: Each search keyword is connected to 121 bits. FIG. 12 shows the search keyword structure. For the monitoring of the attacking IPv4 ICMP frames, the IPSA field is the search keyword.

f) Generation of search request signal: The signals shown in FIG. 20C are sent to the loop monitoring part 4 and the attack monitoring part 5.

(3) Monitoring attacking IPv4 ICMP frames: The monitoring of the attacking IPv4 ICMP frames include the following 2 items.

Item 1: Link band monitoring (the number of received frames, the number of received bytes and the number of erroneous frames are measured for each of the connection terminals Port0 and Port1 in the reception flow rate monitoring part 11).

Item 2: Statistics for the ICMP per IPSA (the attack monitoring part 5 carries out a search (or lookup) with respect to the search engine based on the search request from the frame analyzing part 3, and the following process is carried out depending on the search result since the search result is returned from the search engine).

a) When the search mishits (search fails): The value of the IPSA is written in the ICMP monitoring table per IPSA, and an entry is newly created. The ICMP frame counter per IPSA, which is allocated for each entry within the ICMP frame count table per IPSA, is set to “1” (only the first time).

b) When the search hits (search is successful): The ICMP frame counter per IPSA, allocated for each entry within the ICMP frame count table per IPSA, is incremented (“1” is added to previous value for the second and subsequent times).

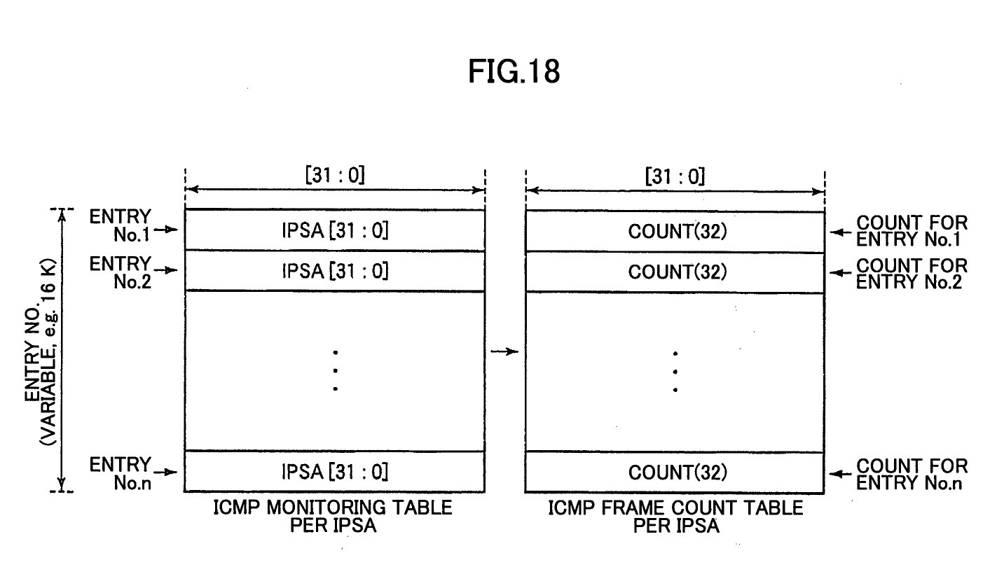

FIG. 18 is a diagram showing a structure of the ICMP monitoring table per attack IPSA.

Detection of Attacking IPv4 ICMP Frame:

Next, a description will be given of the detection techniques employed by the Items 1 and 2 described above under “(3) Monitoring attacking IPv4 ICMP frames”.

Item 1: With respect to link band exceeding detection, the value to be measured is monitored by the reception flow rate monitoring part 11, and it is judged that an attack has been made if the flow rate of the frame exceeds the monitoring threshold value.

Item 2: For detecting statistics of ICMP per IPSA: When the search hits (search is successful): The value of the ICMP frame count per IPSA corresponding to the entry number within the ICMP frame count table per IPSA is read, and compared with the preset threshold value of the frame count. The read frame count number is incremented by “1” and stored in the ICMP frame count table per IPSA. If the read frame count number is greater as a result of the comparison, an attacked state is detected, and an alert (interrupt) is notified to the control part 13 (that is, a failure notification is made). When the control part 13 detects the interrupt, the generation of the attacked state is displayed on the control screen of the abnormal traffic eliminating apparatus, so as to notify the operator of the attacked state.

With regard to the statistics of the attacking IPv4 ICMP frames, the statistical information of the attacking IPv4 ICMP frames is processed and displayed as follows.

Item 1: The ICMP frame count number per IPSA is extracted from the ICMP frame count table per IPSA within the attack monitoring part 5, and the frame count is continued in the ICMP statistic part within the attack statistic part 7. The frame count operation is carried out using the register within the attack statistic part 7. The extracted ICMP frame count number is displayed on the control screen of the abnormal traffic eliminating apparatus, so as to notify the same to the operator.

Item 2: The value of the IPSA having the largest count is extracted from the ICMP monitoring table per IPSA within the attack monitoring part 5 and transferred to the register within the attack statistic part 7. The extracted IPSA value is displayed on the control screen of the abnormal traffic eliminating apparatus, so as to notify the same to the operator.

Identifying Blocking Target of Attacking IPv4 ICMP Frames:

The blocking target of the attacking IPv4 ICMP frames is identified based on the statistical information, by carrying out the following process in a blocking target statistic part within the frame analyzing part 3.

a) Count the number of ICMP frames.

b) Count the number of ICMP bytes.

c) Calculate the band from the number of frames and the number of bytes counted.

The calculated band is displayed on the control screen of the abnormal traffic eliminating apparatus, so as to notify the same to the operator. The operator can hence recognize the band of the ICMP frame, and enter the band from the control screen with respect to the port number that is to be blocked.

Blocking of Attacking IPv4 ICMP Frames:

The attacking IPv4 ICMP frame is blocked by the following process, based on the identification of the blocking target.

(1) Filtering attacking IPv4 ICMP frames: The frame analyzing part 3 identifies the attacking IPv4 ICMP frame by carrying out the following process. When the operator enters the band that is to be blocked from the control screen, the frame analyzing part 3 identifies the ICMP frame from the received frame. In addition, the frame analyzing part 3 adds the flag with respect to the frame which matches the filtering (that is, the frame having the band matching that entered by the operator), and sends the frame that is added with the flag to the frame blocking part 8.

(2) Method of blocking attacking IPv4 ICMP frames: A store-and-forward frame buffer is provided within the frame blocking part 8, and the registration and disposal of the frame is determined when completing the storage of the frame. If the attacking IPv4 ICMP frame is added with the flag, the blocking of the attacking IPv4 ICMP frame is realized by not registering the frame but disposing the frame.

(3) Pass rate for ICMP frame that is blocking target: The pass rate is calculated from the band that is entered by the operator from the control screen of the abnormal traffic eliminating apparatus. In the case of the attacking ICMP frame that is added with the flag, the number of bytes that are actually transmitted is added in units of frames, and the number of transmitting bytes within 100 ms is suppressed by stopping the transmission from the point in time when the number of bytes transmitted in 100 ms exceeds the threshold value (pass rate). Although an excess number of bytes will be generated, the excess number of bytes can be added as the number of bytes in the next 100 ms, so as to limit the band in terms of the average value.

Purging ICMP Monitoring Table Per IPSA, Purging Period, Monitoring Period and Blocking Period:

Periodic purging: In order to constantly monitor the newest network, the ICMP monitoring table per IPSA is periodically purged by the following process. A purge command is periodically (for example, every 30 seconds) issued with respect to the ICMP monitoring table per IPSA (for example, 32 Kwords). The attack monitoring part 5 purges the ICMP monitoring table per IPSA in response to the purge command. The entries of the ICMP monitoring table are all invalidated when the purge command is issued. When the purging is completed, entries are newly made from an address 0 of the ICMP monitoring table per IPSA, and the frame count within the ICMP frame count table per IPSA is started from “1”.

In FIG. 21B, the statistics and the identification of the blocking target are obtained based on the monitoring and statistical information at the time (A), and the blocking is made based on the band entered by the operator at the time (B). The monitoring and statistical processes are carried out between one purge and the next purge, and the blocking process is carried out during the next period.

Further, the present invention is not limited to these embodiments, but various variations and modifications may be made without departing from the scope of the present invention.

1. An abnormal traffic eliminating apparatus for eliminating an abnormal traffic that is generated in a network through which frames including a MAC header part, an IP header part and an IP datagram part are transmitted, comprising:
a write part configured to write a Frame Check Sequence (FCS) field of an MAC frame that is received by a plurality of ports to a search engine part; and
a loop monitoring and detecting part configured to count a number of received MAC frames having identical FCS values and to judge that the network is in a loop state if the number of received MAC frames having the identical FCS values and received within a predetermined time exceeds a preset threshold value.

2. The abnormal traffic eliminating apparatus as claimed in claim 1, comprising:
a loop blocking part configured to block the MAC frames having the identical FCS values within the abnormal traffic eliminating apparatus if the loop monitoring and detecting part detects the loop state of the network, so as not to propagate the loop state in an upstream direction from a branch network towards a core network and in a downstream direction from the core network towards the branch network.

3. The abnormal traffic eliminating apparatus as claimed in claim 2, comprising:
a loop blocking mode selecting part configured to select, in the loop blocking part, an automatic mode for blocking the MAC frames having the identical FCS values by an autonomous operation of hardware or software or, a manual mode for blocking the MAC frames having the identical FCS values in response to an external input to the abnormal traffic eliminating apparatus.

4. The abnormal traffic eliminating apparatus as claimed in claim 2, comprising:
a loop blocking target selecting part configured to select, in the loop blocking part, a blocking target that is to be blocked from all frames passing through the abnormal traffic eliminating apparatus or frames in the loop state detected by the loop monitoring and detecting part.

5. The abnormal traffic eliminating apparatus as claimed in claim 4, comprising:
a loop threshold exceeding frame blocking part configured to block the frames in the loop state and detected as exceeding the threshold value by the loop monitoring and detecting part after the threshold value is exceeded, when the loop blocking target selecting part selects the frames in the loop state as the blocking target.

6. The abnormal traffic eliminating apparatus as claimed in claim 4, comprising:
a loop band limiting part configured to limit a band of the frames in the loop state and detected as exceeding the threshold value by the loop monitoring and detecting part, when the loop blocking target selecting part selects the frames in the loop state as the blocking target.

7. The abnormal traffic eliminating apparatus as claimed in claim 1, comprising:
a statistical information display part configured to display a number of FCS entries exceeding the threshold value, a number of frames in the loop state counted for each FCS entry exceeding the threshold value, and sum total of a number of frames in the loop state counted for the FCS entries exceeding the threshold value, that are detected by the loop monitoring and detecting part.

8. An abnormal traffic eliminating apparatus for eliminating an abnormal traffic that is generated in a network through which frames including a MAC header part, an IP header part and an IP datagram part are transmitted, comprising:
a write part configured to write a TCP/UDP destination port number field of an IPv4 frame that is received from the network to a search engine part; and
a statistic part configured to count a number of received IPv4 frames having identical TCP/UDP destination port numbers and to process statistics for each TCP/UDP destination port number.

9. The abnormal traffic eliminating apparatus as claimed in claim 8, comprising:
a part configured to extract, in the statistic part, a predetermined number of top TCP/UDP destination port numbers having larger counts of received frames, a number of received frames for each TCP/UDP destination port number, and an IPSA value for each TCP/UDP destination port number.

10. The abnormal traffic eliminating apparatus as claimed in claim 9, comprising:
a blocking target determining part configured to determine the TCP/UDP destination port number that is the blocking target by analyzing extracted information in the statistic part.

11. The abnormal traffic eliminating apparatus as claimed in claim 10, comprising:
a pass rate determining part configured to determine a pass rate by processing statistics of the number of received IPv4 frames having the TCP/UDP destination port number that is the blocking target and the number of received bytes in the blocking target determining part.

12. The abnormal traffic eliminating apparatus as claimed in claim 11, comprising:
a band limiting part configured to limit a band by passing attacking IPv4 frames for the pass rate set in the pass rate determining part.

13. The abnormal traffic eliminating apparatus as claimed in claim 9, comprising:
a display part configured to display an attack source of an attacking IPv4 frame by analyzing the extracted IPSA information in the statistic part.

14. The abnormal traffic eliminating apparatus as claimed in claim 12, comprising:
a selecting part configured to select, in the band limiting part, an automatic mode for limiting the band by an autonomous operation of hardware or software or, a manual mode for limiting the band in response to an external input to the abnormal traffic eliminating apparatus.

15. An abnormal traffic eliminating apparatus for eliminating an abnormal traffic that is generated in a network through which frames including a MAC header part, an IP header part and an IP datagram part are transmitted, comprising:
a write part configured to write a TCP/UDP destination port number field, a Protocol field and an IPSA field of an IPv4 frame that is received from the network to a search engine part; and
a statistic part configured to count a number of received IPv4 frames having identical TCP/UDP destination port number fields, Protocol fields and IPSA fields, and to process statistics for each TCP/UDP destination port number per IPSA.

16. An abnormal traffic eliminating apparatus for eliminating an abnormal traffic that is generated in a network through which frames including a MAC header part, an IP header part and an IP datagram part are transmitted, comprising:
a write part configured to write an IPDA field and an IPSA field of an IPv4 frame that is received from the network to a search engine part; and
a statistic part configured to count a number of received IPv4 frames having identical IPDA fields and IPSA fields, and to process statistics for an IP destination port number per IPSA.

17. An abnormal traffic eliminating apparatus for eliminating an abnormal traffic that is generated in a network through which frames including a MAC header part, an IP header part and an IP datagram part are transmitted, comprising:
a write part configured to write an IPSA field of an ARP frame that is received from the network to a search engine part; and
a statistic part configured to count a number of received ARP frames having identical IPSA fields and to process statistics for an ARP frame number per IPSA.

18. The abnormal traffic eliminating apparatus as claimed in claim 12, comprising:
a part configured to extract, in the statistic part, a count of the number of received frames and an IPSA value.

19. The abnormal traffic eliminating apparatus as claimed in claim 18, comprising:
a blocking target determining part configured to determine the ARP frame that is the blocking target by analyzing extracted information in the statistic part.

20. The abnormal traffic eliminating apparatus as claimed in claim 19, comprising:
a pass rate determining part configured to determine a pass rate by processing statistics of the number of received ARP frames that are the blocking target and the number of received bytes in the blocking target determining part.

21. The abnormal traffic eliminating apparatus as claimed in claim 20, comprising:
a band limiting part configured to limit a band by passing attacking ARP frames for the pass rate set in the pass rate determining part.

22. The abnormal traffic eliminating apparatus as claimed in claim 18, comprising:
a display part configured to display an attack source of an attacking ARP frame by analyzing the extracted IPSA information in the statistic part.

23. The abnormal traffic eliminating apparatus as claimed in claim 21, comprising:
a selecting part configured to select, in the band limiting part, an automatic mode for limiting the band by an autonomous operation of hardware or software or, a manual mode for limiting the band in response to an external input to the abnormal traffic eliminating apparatus.

24. An abnormal traffic eliminating apparatus for eliminating an abnormal traffic that is generated in a network through which frames including a MAC header part, an IP header part and an IP datagram part are transmitted, comprising:
a write part configured to write an IPSA field of an ICMP frame that is received from the network to a search engine part; and
a statistic part configured to count a number of received ICMP frames having identical IPSA fields and to process statistics for an ICMP frame number per IPSA.

25. The abnormal traffic eliminating apparatus as claimed in claim 24, comprising:
a part configured- to extract, in the statistic part, a count of the number of received frames and an IPSA value.

26. The abnormal traffic eliminating apparatus as claimed in claim 25, comprising:
a blocking target determining part configured to determine the ICMP frame that is the blocking target by analyzing extracted information in the statistic part.

27. The abnormal traffic eliminating apparatus as claimed in claim 26, comprising:
a pass rate determining part configured to determine a pass rate by processing statistics of the number of received ICMP frames that is the blocking target and the number of received bytes in the blocking target determining part.

28. The abnormal traffic eliminating apparatus as claimed in claim 27, comprising:
a band limiting part configured to limit a band by passing attacking ICMP frames for the pass rate set in the pass rate determining part.

29. The abnormal traffic eliminating apparatus as claimed in claim 26, comprising:
a display part configured to display an attack source of an attacking ICMP frame by analyzing the extracted IPSA information in the statistic part.

30. The abnormal traffic eliminating apparatus as claimed in claim 28, comprising:
a selecting part configured to select, in the band limiting part, an automatic mode for limiting the band by an autonomous operation of hardware or software or, a manual mode for limiting the band in response to an external input to the abnormal traffic eliminating apparatus.

31. An abnormal traffic eliminating apparatus for eliminating an abnormal traffic that is generated in a network through which frames including a MAC header part, an IP header part and an IP datagram part are transmitted, comprising:
a monitoring part comprising a first part configured to determine whether or not a traffic flow rate of MAC frames received by a plurality of ports exceeds a first threshold value, a second part configured to determine whether or not a number of IPv4 frames received from the network and having identical TCP/UDP destination port numbers exceeds a second threshold value, a third part configured to determine whether or not a number of IPv4 frames received from the network and having identical TCP/UDP destination port number fields, Protocol fields and IPSA fields exceeds a third threshold value, a fourth part configured to determine whether or not a number of received IPv4 frames received from the network and having identical IPDA fields and IPSA fields exceeds a fourth threshold value, a fifth part configured to determine whether or not a number of ARP frames received from the network and having identical IPSA fields exceeds a fifth threshold value, and a sixth part configured to determine whether or not a number of ICMP frames received from the network and having identical IPSA fields exceeds a sixth threshold value; and
a monitoring and detecting part configured to judge that an abnormal traffic has occurred due to an attack if one of the first through sixth threshold values is exceeded in the monitoring part continuously for a predetermined time.

32. The abnormal traffic eliminating apparatus as claimed in claim 31, comprising:
a statistic part configured to carry out counting and statistic operations of the first through fourth parts in parallel.

33. The abnormal traffic eliminating apparatus as claimed in claim 31, comprising:
a statistic part configured to carry out counting and statistic operations of the first and fifth parts in parallel.

34. The abnormal traffic eliminating apparatus as claimed in claim 31, comprising:
a statistic part configured to carry out counting and statistic operations of the second through fourth parts in parallel.

35. The abnormal traffic eliminating apparatus as claimed in claim 31, comprising:
a purge part configured to purge a portion of a corresponding monitoring table, where entries are written, within a search engine, in at least one of the first through sixth parts, so as to periodically update the monitoring target.

36. The abnormal traffic eliminating apparatus as claimed in claim 35, comprising:
a blocking part configured to determine the blocking target by processing the statistics in at least one of the first, fifth and sixth parts while purging the corresponding monitoring table, and to block the blocking target during a next purging of the corresponding monitoring table.

37. An abnormal traffic eliminating apparatus for eliminating an abnormal traffic that is generated in a network through which frames including a MAC header part, an IP header part and an IP datagram part are transmitted, comprising:
a divided mode in which monitoring, detecting, statistical and blocking operations with respect to loop/attacking frames received by a plurality of ports are carried out for each physical port number of the ports, said frames including IPv4 TCP/UDP frames, IPv4 ARP frames and IPv4 ICMP frames;
a shared mode in which the monitoring, detecting, statistical and blocking operations with respect to the loop/attacking frames received by the plurality of ports are carried out without separating the process for each physical port number of the ports; and
a selecting part configured to select and carrying out the process in the divided mode or the shared mode.
